(19) United States
(12) Patent Application Publication
(10) Pub. No.: US 2015/0234305 A1
(43) Pub. Date: Aug. 20, 2015

(54) POLYESTER RESIN FOR TONER, TONER FOR ELECTROSTATIC CHARGE IMAGE DEVELOPMENT, AND TONER CARTRIDGE

(71) Applicant: FUJI XEROX CO., LTD., Tokyo (JP)

(72) Inventors: Yuki SASAKI, Yokohama-shi (JP); Sumiaki YAMASAKI, Minamiashigara-shi (JP); Shiori CHONAN, Minamiashigara-shi (JP)

(21) Appl. No.: 14/481,284

(22) Filed: Sep. 9, 2014

(30) Foreign Application Priority Data
Feb. 19, 2014 (JP) 2014-029703
Feb. 19, 2014 (JP) 2014-029979

(51) Int. Cl. G03G 9/087; C08G 63/183

(52) U.S. Cl. CPC G03G 9/08755; C08G 63/183

(57) ABSTRACT

There is provided a polyester resin for a toner, which is a polycondensate of (A) a polycarboxylic acid component and a polyol component including (B) polyol represented by the specific general formula and (C) a chain-like aliphatic polyol, wherein the total amount of (B) the polyol represented by the specific general formula and (C) the chain-like aliphatic polyol is 60 mol % to 100 mol % in the entire alcohol components, and the molar ratio ((B)/(C)) of (B) the polyol represented by the specific general formula to (C) the chain-like aliphatic polyol is 0.1 to 1.0.

### CROSS-REFERENCE TO RELATED APPLICATIONS

This application is based on and claims priority under 35 USC 119 from Japanese Patent Application No. 2014-29703 and Japanese Patent Application No. 2014-29979, each filed on Feb. 19, 2014.

### BACKGROUND

1. Field

The present invention relates to a polyester resin for a toner, a toner for electrostatic charge image development, and a toner cartridge.

2. Description of the Related Art

As an electrophotographic method, a method in which an electrostatic latent image is formed, and through a step of developing the electrostatic latent image, image information is visualized is currently used in various fields.

Formation of an image by the method is performed in the following manner. First, after charging the whole photoreceptor (latent image carrier) surface, the photoreceptor surface is exposed to a laser beam according to the image information to form an electrostatic latent image, and next, the obtained electrostatic latent image is developed with a developer containing a toner to form a toner image, and the obtained toner image is transferred and fixed on the recording medium surface.

As the toner applied to the electrophotographic method as described above, the followings are known.

For example, JP-A-2012-172027 discloses an electrophotographic toner including resin particles consisting of a polyester resin in which the compound represented by the following chemical formula (here, in the formula, X represents an aliphatic group or an aromatic group, Y represents disproportionated rosin residue, disproportionated rosin residue, or hydrogenated rosin residue, and n is an integer of 0 or 1.) is an essential component of an alcohol component.

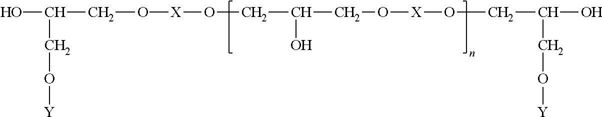

JP-A-2012-149254 discloses a polyester resin which contains at least one of diacid, acid ester, or diester; and a polycondensation product of at least one diol, in which at least one of diacid, acid ester, or diester includes rosin diacid, rosin acid ester, or rosin diester, or at least one diol includes rosin diol.

JP-A-2012-229413 discloses a polyester resin for a toner which contains a repeating unit derived from a dicarboxylic acid component and a repeating unit derived from a dialcohol component represented by the following general formula (1A) and has an acid value of 3 mg KOH/g to 30 mg KOH/g.

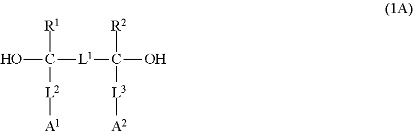

(In the general formula (1A), each of R¹ and R² independently represents a hydrogen atom or a methyl group. Each of L¹, L², and L³ independently represents a carbonyl group, an ester group, an ether group, a sulfonyl group, a chain-like alkylene group that may have a substituent, a cyclic alkylene group that may have a substituent, an arylene group that may have a substituent, or a divalent linking group selected from a group consisting of combination thereof, and L¹ and L² or L¹ and L³ may form a ring. Each of A¹ and A² represents a rosin ester group.)

JP-A-2011-246650 discloses a polyester resin in which the compound represented by the following chemical formula (here, in the formula, X represents an aliphatic group or an aromatic group, Y represents disproportionated rosin residue, disproportionated rosin residue, or hydrogenated rosin residue, and n is an integer of 0 or 1.) is an essential component of an alcohol component.

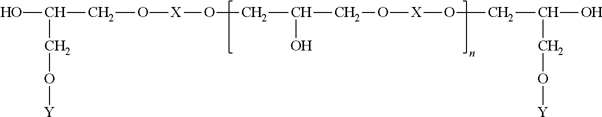

JP-A-2013-064059 discloses a polyester resin for an electrostatic charge image developing toner which is a polycondensate of polycarboxylic acid, aromatic polyol including rosin, and aliphatic polyol including the rosin.

### SUMMARY

[1] A polyester resin for a toner, which is a polycondensate of (A) a polycarboxylic acid component and a polyol component including (13) polyol represented by the following general formula (1) and (C) a chain-like aliphatic polyol,

wherein the total amount of (B) the polyol represented by the general formula (1) and (C) the chain-like aliphatic polyol is 60 mol % to 100 mol % in the entire alcohol components, and the molar ratio ((B)/(C)) of (B) the polyol represented by the general formula (1) to (C) the chain-like aliphatic polyol is 0.1 to 1.0:

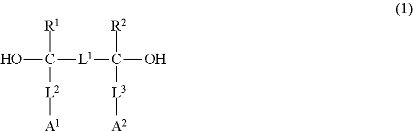

in the general formula (1),

each of R¹ and R² independently represents a hydrogen atom or a methyl group,

L¹ represents a chain-like alkylene group that may have a substituent, or a divalent group obtained by combining the chain-like alkylene group and an ester group or an ether group,

each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, or a divalent group obtained by combination thereof, and

L¹ and L² or L¹ and L³ may form a ring,

each of A¹ and A² represents a rosin ester group.

### BRIEF DESCRIPTION OF THE DRAWINGS

FIG. 1 is a diagram illustrating a state of a screw as an example of a screw extruder used in producing a toner according to the exemplary embodiment.

FIG. 2 is a schematic configuration view showing an example of an image forming apparatus according to the exemplary embodiment.

FIG. 3 is a schematic configuration view showing an example of a process cartridge according to the exemplary embodiment.

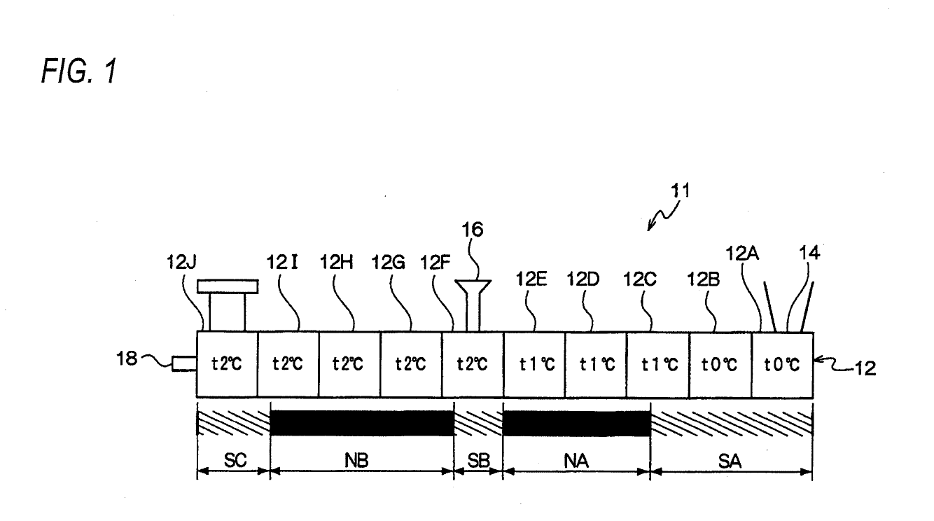

In the FIGS. 1Y, 1M, 1C, 1K, 107 denote Photoreceptor (image carrier); 2Y, 2M, 2C, 2K denote Charging roller; 3Y, 3M, 3C, 3K denote Laser beam; 3 denotes Exposure device; 4Y, 4M, 4C, 4K, 111 denote Developing device (developing means); 5Y, 5M, 5C, 5K denote Primary transfer roller; 6Y, 6M, 6C, 6K, 113 denote Photoreceptor cleaning device (cleaning means); 8Y, 8M, 8C, 8K denote Toner cartridge; 10Y, 10M, 10C, 10K denote Unit; 20 denotes Intermediate transfer belt; 22 denotes Drive roller; 24 denotes Support roller; 26 denotes Secondary transfer roller (transferring means); 28, 115 denote Fixing device (fixing means); 30 denotes Intermediate transfer member cleaning device; 32 denotes Transport roll (discharging roll); 108 denotes Charging device; 112 denotes Transfer device; 116 denotes Mounting rail; 117 denotes Opening portion for destaticization exposure; 118 denotes Opening portion for exposure; 200 denotes Process cartridge; P, 300 denote Recording paper (recording medium).

### DETAILED DESCRIPTION

Hereinafter, an exemplary embodiment, which is an example, for the polyester resin for a toner, the toner for electrostatic charge image development, the electrostatic charge image developer, the toner cartridge, the process cartridge, the image forming apparatus, and the image forming method of the invention will be shown and described in detail.

### <Polyester Resin for a Toner>

The polyester resin for a toner according to the first exemplary embodiment is a polycondensate of (A) a polycarboxylic acid component, and a polyol component including (B) polyol represented by the following general formula (1) and (C) a chain-like aliphatic polyol, in which the total amount of (B) the polyol represented by the following general formula (1) and (C) the chain-like aliphatic polyol is 60 mol % to 100 mol % in the entire alcohol components, and the molar ratio ((B)/(C)) of (B) the polyol represented by the following general formula (1) to (C) the chain-like aliphatic polyol is 0.1 to 1.0.

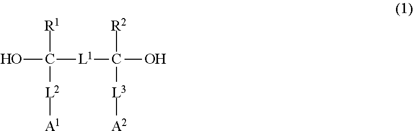

In the above general formula (1), each of R¹ and R² independently represents a hydrogen atom or a methyl group. L¹ represents a chain-like alkylene group that may have a substituent, or a divalent group obtained by combining the chain-like alkylene group and an ester group or an ether group, and each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, or a divalent group obtained by combination thereof, and L¹ and L² or L¹ and L³ may form a ring. Each of A¹ and A² represents a rosin ester group.

For the polyester resin for a toner according to the first exemplary embodiment, when applied to the toner for electrostatic charge image development, the low temperature fixability is realized by the structure described above.

The reason for this is not clear, but is considered to be as follows.

Rosin is a molecule which has high hydrophobicity, a high volume, a high molecular weight. A polyester resin including the rosin skeleton on the side chain hardly contains water, and when it is applied to a toner, the electrostatic property (in particular, the electrostatic property in a high temperature and a high humidity) can be increased.

However, for the polyester resin regularly including the rosin skeleton on the side chain, due to bulkiness and rigidity which the rosin skeleton has, there is a tendency that viscosity reduction with respect to temperature is slow, and regarding the low temperature fixability when it is applied to a toner, though it is not sufficient, various studies are being made at present.

In the first exemplary embodiment, it is one of the characteristics that as the polyol component used for obtaining the polyester resin, the polyol represented by a general formula (1) and (C) the chain-like aliphatic polyol are used.

It is considered that by using (B) the polyol represented by the general formula (1) in which L¹ in the general formula (1) is a chain-like alkylene group which may include an ester group or an ether group and (C) the chain-like aliphatic polyol including a chain-like aliphatic group in combination, flexibility can be imparted to the main chain of the polyester resin. It is considered that by the flexibility of the main chain, it is possible to moderate the bulkiness and the rigidity which the rosin skeleton has and realize a so-called low temperature fixing.

In particular, in the first exemplary embodiment, the total amount of (B) the polyol represented by the general formula (1) and (C) the chain-like aliphatic polyol is 60 mol % to 100 mol % in the entire alcohol components, and the molar ratio of (B) the polyol represented by the following general formula (1) to (C) the chain-like aliphatic polyol is 0.1 to 1.0. It is considered that when the content and the molar ratio are in the above ranges, even while maintaining high electrostatic property due to the rosin skeleton on the side chain, flexibility can be imparted to the main chain and viscosity reduction at a low temperature can be exhibited.

From these, the polyester resin according to the first exemplary embodiment is suitable for toner applications, and when it is applied to a toner, the low temperature fixability can be realized.

Though JP-A-2012-172027 discloses the polyester resin regularly including the rosin skeleton on the side chain, as a specific example, it discloses only that a bisphenol A skeleton is included in X in the compound represented by the above-described chemical formula. It is considered that if having the structure of the specific example, the flexibility of the main which moderates the bulkiness and the rigidity of the rosin skeleton as described above is less likely to be obtained, and the viscosity reduction at a low temperature as that in the polyester resin according to the first exemplary embodiment is less likely to be exhibited.

In addition, though JP-A-2012-229413 discloses the polyester resin regularly including the rosin skeleton on the side chain, as a specific example, it discloses only a structure in which a dialcohol component represented by the following general formula (1) is used in a large amount with respect to other dialcohol components. It is considered that if having such a structure, the flexibility of the main chain which moderates the bulkiness and the rigidity of the rosin skeleton is less likely to be obtained, and the viscosity reduction at a low temperature as that in the polyester resin according to the first exemplary embodiment is less likely to be exhibited.

Moreover, it is estimated that in the first exemplary embodiment, in a case where L¹ in general formula (1) includes an alkylene group having 3 or less carbon atoms, in a case where L¹ in general formula (1) includes an alkylene group having a methyl group as a substituent, in a case where L¹ in general formula (1) includes an ester group or an ether group, in a case where a chain-like aliphatic group in chain-like aliphatic polyol is an alkylene group having 3 or less carbon atoms, and in a case where a chain-like aliphatic group in chain-like aliphatic polyol is an alkylene group having a methyl group as a substituent, the repeating unit may become asymmetric or the polyester resin is likely to take a structure bent derived from an alkyl group or an ester or ether group skeleton, and thus the main chain structure of the polyester resin is less likely to take a determined ordered structure. It is considered that the irregularity of the main chain structure, in particular, effectively moderates the bulkiness and the rigidity which the rosin skeleton has, imparts the preferable flexibility, and thus the viscosity reduction at a lower temperature can be realized.

Hereinafter, a monomer component to obtain the polyester resin for a toner (hereinafter, also referred to as a specific polyester resin (according to the first exemplary embodiment).) according to the first exemplary embodiment, that is, (A) the polycarboxylic acid component, (B) the polyol represented by the general formula (1), and (C) the chain-like aliphatic polyol will be described in detail.

### [(A) Polycarboxylic Acid Component]

(A) The polycarboxylic acid component used for obtaining the specific polyester resin will be described.

As (A) the polycarboxylic acid component, as described below, at least one selected from a group consisting of aromatic dicarboxylic acid including an aromatic structure and aliphatic dicarboxylic acid including an aliphatic structure is preferable.

Specific examples of the aromatic dicarboxylic acid and the aliphatic dicarboxylic acid include aromatic dicarboxylic acids such as phthalic acid, isophthalic acid, terephthalic acid, 1,4-naphthalene dicarboxylic acid, and 2,6-naphthalene dicarboxylic acid; aliphatic dicarboxylic acids such as oxalic acid, malonic acid, maleic acid, fumaric acid, citraconic acid, itaconic acid, glutaconic acid, succinic acid, glutaric acid, adipic acid, sebacic acid, azelaic acid, dimer acid, alkyl succinic acid having a carbon number of 1 to 20 with a branched chain, and alkenylene succinic acid having an alkenyl group having a carbon number of 1 to 20 with a branched chain; anhydrides of the acids thereof; and alkyl (having a carbon number of 1 to 3) esters of the acids thereof

These aromatic dicarboxylic acids and aliphatic dicarboxylic acids may be used alone, or two or more kinds thereof may be used in combination.

Among these, from the viewpoint of durability, fixability of a toner, and dispersibility of a colorant when applied to the toner, and from the viewpoint of availability, aromatic dicarboxylic acids such as isophthalic acid and terephthalic acid, and aliphatic dicarboxylic acid such as succinic acid, glutaric acid, sebacic acid, and azelaic acid are preferable.

In addition, from the viewpoint of further improving the low temperature fixability of a toner when applied to the toner, as (A) the polycarboxylic acid component, dicarboxylic acid including an aromatic structure (aromatic dicarboxylic acid) and dicarboxylic acid including a chain-like aliphatic structure having a carbon number of 4 or less are preferably used in combination. Here, a carbon number of 4 or less means that the number of carbon atoms in a chain-like aliphatic structure, excluding carbon atoms constituting the carboxyl group is 4 or less.

Specifically, aromatic dicarboxylic acids such as isophthalic acid, terephthalic acid, anhydrous phthalic acid, 1,4-naphthalene dicarboxylic acid, and 2,6-naphthalene dicarboxylic acid, and aliphatic dicarboxylic acids such as succinic acid (carbon number: 2 (2 carbon atoms)), adipic acid (carbon number: 4), and glutaric acid (carbon number: 3) are preferably used in combination.

In a case of using two types of the dicarboxylic acid components in combination in this manner, it is desirable that 2 mol % to 15 mol % (desirably 3 mol % to 10 mol %) of the entire dicarboxylic acid components used in combination is dicarboxylic acid including a chain-like aliphatic structure having a carbon number of 4 or less, from the viewpoint of the balance between the fixability and powder characteristics when applied to a toner.

In addition, within a range not impairing the effect of the first exemplary embodiment, as (A) the polycarboxylic acid component, tri- or higher carboxylic acids may also be used. Here, the content of tri- or higher carboxylic acid in (A) the polycarboxylic acid component may be 10 mol % or less (preferably 5 mol % or less).

Examples of the tri- or higher (valent) carboxylic acids include aromatic carboxylic acids such as trimellitic acid, pyromellitic acid, naphthalene tricarboxylic acid, benzophenone tetracarboxylic acid, biphenyl tetracarboxylic acid, and anhydrides thereof, and these may be used alone, or two or more kinds thereof may be used in combination.

As the tri- or higher aromatic carboxylic acids, trimellitic anhydride is preferable from the viewpoint of availability or reactivity.

### [(B) Polyol Represented by the General Formula (1)]

Next, (B) the polyol represented by the general formula (1) which is one of the polyol components used for obtaining the specific polyester resin will be described.

The polyol represented by the following general formula (1) is so-called diol containing two rosin ester groups in one molecule and having two alcoholic hydroxyl groups in a molecule (hereinafter, also referred to as “specific rosin diol”).

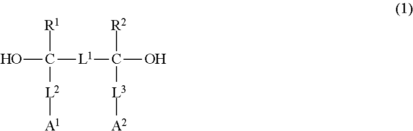

In the above general formula (1), each of R¹ and R² independently represents a hydrogen or a methyl group. L¹ represents a chain-like alkylene group that may have a substituent, or a divalent group obtained by combining the chain-like alkylene group and an ester group or an ether group, and each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, or a divalent group obtained by combination thereof, and L¹ and L² or L¹ and L³ may form a ring. Each of A¹ and A² represents a rosin ester group.

Here, the rosin ester group means a residue excluding hydrogen atoms from a carboxyl group included in rosin.

Examples of the chain-like alkylene group represented by the L¹ include a chain-like alkylene group having a carbon number of 1 to 10, and among these, a chain-like alkylene group having a methyl group as a substituent is preferable.

As the L¹, a divalent group obtained by combining the chain-like alkylene group and an ester group or an ether group is preferable. Among these, as the L¹, a divalent group obtained by combining a methylene group, an ether group, and an alkylene group having a total carbon number of 2 to 8 are preferable, a divalent group obtained by combining a methylene group, an ether group, and an alkylene group having a total carbon number of 2 to 5 are more preferable. Moreover, among the preferable aspects, the L¹ in which two methylene groups are present and the two methylene groups are present at both ends of L¹ is preferable. Here, the total carbon number means that in a case of having a substituent including a carbon atom, the total number of carbon number including the carbon atom number in the substituent.

As specific examples of L¹, a divalent group having the structure of the followings 1 to 8 is preferable. In addition, n is an integer of 2 or greater.

Among the divalent group described below, the structures of 1, 2, 3, and 5 are preferable, and structures of 1 and 5 having a methyl group as a substituent are particularly preferable.

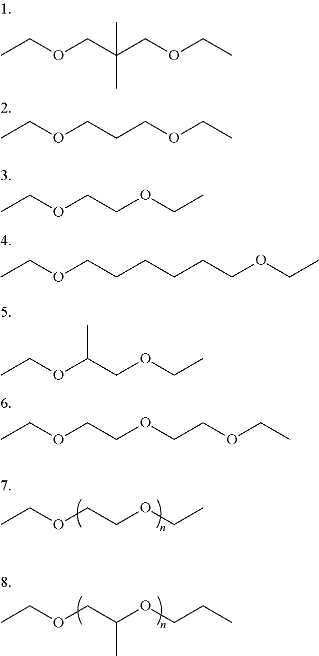

Examples of the chain-like alkylene group represented by the L² and L³ include an alkylene group having a carbon number of 1 to 10.

Examples of the cyclic alkylene group represented by the L² and L³ include a cyclic alkylene group having a carbon number of 3 to 7.

Examples of the arylene group represented by the L² and L³ include a phenylene group, a naphthylene group, and an anthracene group.

L² and L³ is preferably a chain-like alkylene group, more preferably a chain-like alkylene group having a carbon number of 1 to 2.

As the example of the substituent introduced into the chain-like alkylene group, the cyclic alkylene group, or the arylene group, an alkyl group having a carbon number of 1 to 8, and an aryl group can be exemplified, and a linear, a branched, or a cyclic alkyl group is preferable. Specific examples thereof include a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclopentyl group, a cyclohexyl group, and a phenyl group.

Next, the synthetic method of the specific rosin diol represented by the general formula (1) will be specifically described.

The specific rosin diol represented by the general formula (1) is synthesized by a known method, for example, a reaction of an epoxy compound and rosin.

The epoxy compound which may be used in the first exemplary embodiment is a bifunctional epoxy compound including two epoxy groups in one molecule, and diglycidyl ether of aliphatic diol which is L¹ in the general formula (1) and the like can be exemplified.

In this manner, by synthesizing the specific rosin diol using a polyfunctional epoxy compound, for example, a toner having more excellent electrostatic property can be obtained from the specific polyester resin including a repeating unit derived from such a specific rosin diol. This is because the reactivity of the epoxy compound is higher than the reactivities of other general-purpose functional alcohols, and thus, carboxylic acid with a low reactivity having rosin is efficiently reacted. As a result, the reverse reaction or the side reaction also is suppressed.

Since the reactivity of the epoxy compound is higher than the reactivities of other general-purpose functional alcohols, carboxylic acid with a low reactivity having rosin is efficiently reacted. As a result, the reverse reaction or the side reaction also is suppressed.

As representative examples of the diglycidyl ether of aliphatic diol, ethylene glycol, 1,2-propanediol, 1,3-propanediol, 1,4-butanediol, 1,5-pentanediol, 1,6-hexanediol, neopentyl glycol, 1,9-nonanediol, diethylene glycol, triethylene glycol, polyethylene glycol, polypropylene glycol, and polytetramethylene glycol as an aliphatic diol component can be exemplified.

Among these, ethylene glycol, 1,2-propanediol, 1,3-propanediol, 1,4-butanediol, 1,6-hexanediol, neopentyl glycol, and diethylene glycol can be preferably exemplified.

For example, the epoxy group-containing compound is obtained by a reaction of a diol component and epihalohydrin.

A reaction of rosin and a bifunctional epoxy compound is proceeded mainly by a ring opening reaction of a carboxyl group of rosin and an epoxy group of a bifunctional epoxy compound. At that time, as the reaction temperature, a temperature above the melting temperatures of both constituents and/or capable of homogeneous mixing is preferable, and specifically, a range of 60° C. to 200° C. is general. During the reaction, a catalyst for promoting the ring opening reaction of the epoxy group may be added.

Examples of the catalyst include amines such as ethylenediamine, trimethylamine, and 2-methyl imidazole, quaternary ammonium salts such as, triethyl ammonium bromide, triethyl ammonium chloride, and butyltrimethyl ammonium chloride, and triphenylphosphine.

The reaction can be performed in various methods. For example, generally, in a case of a batch type, rosin and a bifunctional epoxy compound at a predetermined ratio are put into a heatable flask equipped with a cooling tube, a stirrer, an inert gas inlet, a thermometer, and the like, and the mixture is heated and melted. The reaction product is suitably sampled, therefore, the progress of the reaction is checked. The progress of the reaction is confirmed by a decrease in an acid value, and for example, at a stoichiometric reaction ending point or at the time when the reaction reaches the vicinity of the ending point, the reaction is suitably finished.

As the reaction ratio of the rosin and the bifunctional epoxy compound, preferably, the reaction is proceeded in a range of 1.5 moles to 2.5 moles of the rosin with respect to 1 mole of the bifunctional epoxy resin, more preferably, the reaction is proceeded in a range of 1.8 moles to 2.2 moles of the rosin with respect to 1 mole of the bifunctional epoxy resin, and most preferably, the reaction is proceeded in a range of 1.85 moles to 2.1 moles of the rosin with respect to 1 mole of the bifunctional epoxy resin. When the rosin is less than 1.5 moles, the epoxy groups of the bifunctional epoxy compound remains in the polyester production step which is the next step, this acts as a crosslinking agent, by this action, a rapid increase in the molecular weight is caused, and thus there is a fear of gelation. On the other hand, when the rosin is more than 1.5 moles, the unreacted rosin remains, and this causes deterioration of the electrostatic property due to increase in the acid value.

Next, the rosin in a specific rosin diol represented by the general formula (1) will be described.

Rosin is a generic term for resin acids obtained from trees, and a material derived from natural products including abietic acid in which a main component is one of tricyclic diterpenes and isomers of these. Examples of the specific component include palustric acid, neoabietic acid, pimaric acid, dehydroabietic acid, isopimaric acid, sandaracopimaric acid in addition to abietic acid, and the rosin used in the first exemplary embodiment is a mixture thereof. In the classification of the rosin according to the collecting methods, the rosin are divided broadly into three types, that is, tall rosin of which a raw material is pulp, gum rosin of which a raw material is a raw pine resin, and wood rosin of which a raw material is a stump of pine. Since the rosin can be easily obtained, at least one of the gum rosin and the tall rosin is preferable.

These rosins are preferably purified, and for example, purified rosin can be obtained by removing a high molecular weight material which is considered to be generated from peroxide of resin acid in crude rosins or unsaponified material which is included in the crude resin. As the purification method, which is not particularly limited, various purification methods known in the related art can be selected. Specific examples thereof include distillation, recrystallization, and extraction. Industrially, purification by distillation is preferably performed. In general, distillation is performed at 200° C. to 300° C., and at a pressure of 6.67 kPa or less in consideration of distillation time. Recrystallization, for example, is performed in the following manner. First crude rosin is dissolved in a good solvent, the solvent is distilled to make a concentrated solution, and then a poor solvent is added to the solution. Examples of the good solvent include aromatic hydrocarbons such as benzene, toluene, and xylene, chlorinated hydrocarbons such as chloroform, alcohols such as lower alcohol, ketones such as acetone, and acetic acid esters such as ethyl acetate, and examples of the poor solvent include hydrocarbon-based solvents such as n-hexane, n-heptane, cyclohexane, and isooctane. Extraction, for example, is a method in which alkaline water is used to crude rosin to make an alkali aqueous solution, the insoluble unsaponified material included therein is extracted using an organic solvent, and then the aqueous layer is neutralized, whereby purified rosin is obtained.

The rosin may be a disproportionated rosin. The disproportionated rosin is rosin in which unstable conjugated double bonds in a molecule are eliminated by high-temperature-heating rosin including abietic acid as a main component in the presence of a disproportionation catalyst, and a main component thereof is a mixture of dehydroabietic acid and dihydroabietic acid.

Examples of the disproportionation catalyst include various catalysts known including supported catalysts such as palladium carbon, rhodium carbon, and platinum carbon, metal powder such as nickel and platinum, iodides such as iodine and iron iodide, and a phosphorus-based compound. In general, the used amount of the catalyst is preferably 0.01% by mass to 5% by mass with respect to rosin, more preferably 0.01% by mass to 1% by mass, and the reaction temperature is preferably 100° C. to 300° C., and more preferably 150° C. to 290° C. Moreover, as a method of controlling the amount of dehydroabietic acid, for example, dehydroabietic acid isolated by a method (J. Org. Chem., 31, 4246 (1996)) of crystallizing ethanolamine salt from the disproportionated rosin may be added so as to be in the above range.

The rosin may be a hydrogenated rosin. For example, the hydrogenated rosin includes tetrahydroabietic acid and dihydroabietic acid as a main component, and is obtained by eliminating unstable conjugated double bonds in a molecule by a known hydrogenation reaction. In general, the hydrogenation reaction is performed by heating crude rosin under the hydrogen pressure of 10 kg/cm² to 200 kg/cm², preferably 50 kg/cm² to 150 kg/cm² in the presence of a hydrogenation catalyst. Examples of the hydrogenation catalyst include various catalysts known including supported catalysts such as palladium carbon, rhodium carbon, and platinum carbon, metal powder such as nickel and platinum, iodides such as iodine and iron iodide, and a phosphorus-based compound. In general, the used amount of the catalyst is 0.01% by mass to 5% by mass with respect to rosin, preferably 0.01% by mass to 1.0% by mass, and the reaction temperature is 100° C. to 300° C., and preferably 150° C. to 290° C.

These disproportionated rosins and hydrogenated rosins may be subjected to the above purification step before and after a disproportionation treatment or a hydrogenation treatment.

The rosin may be polymerized rosin obtained by polymerizing rosin, unsaturated carboxylic acid-modified rosin obtained by adding unsaturated carboxylic acid to rosin, and phenol-modified rosin. Moreover, examples of the unsaturated carboxylic acid used in preparation of unsaturated carboxylic acid-modified rosin include maleic acid, maleic anhydride, fumaric acid, acrylic acid, and methacrylic acid. The unsaturated carboxylic acid-modified rosin is modified using generally about 1 part by mass to about 30 parts by mass of unsaturated carboxylic acid with respect to 100 parts by mass of raw material rosin.

Among rosins, in order to uniformize reactivity and obtain a homogeneous specific polyester resin in which residual monomers or side reactions are suppressed, rosin purified by a purification treatment, rosin disproportionated by a disproportionation treatment, or rosin hydrogenated by a hydrogenation treatment is preferably used. These may be used singly or as any mixture thereof. The homogeneous specific polyester resin has an advantage that control of the electrostatic property of a toner is easier.

In addition, by applying these rosins, phase dissolution of a toner is further increased, and as a result, uniformity of image gloss at the time of low temperature fixing or low pressure fixing at a high speed is easily further improved.

Exemplary compounds of the specific rosin diol represented by the general formula (1) are shown below, but the first exemplary embodiment is not limited thereto.

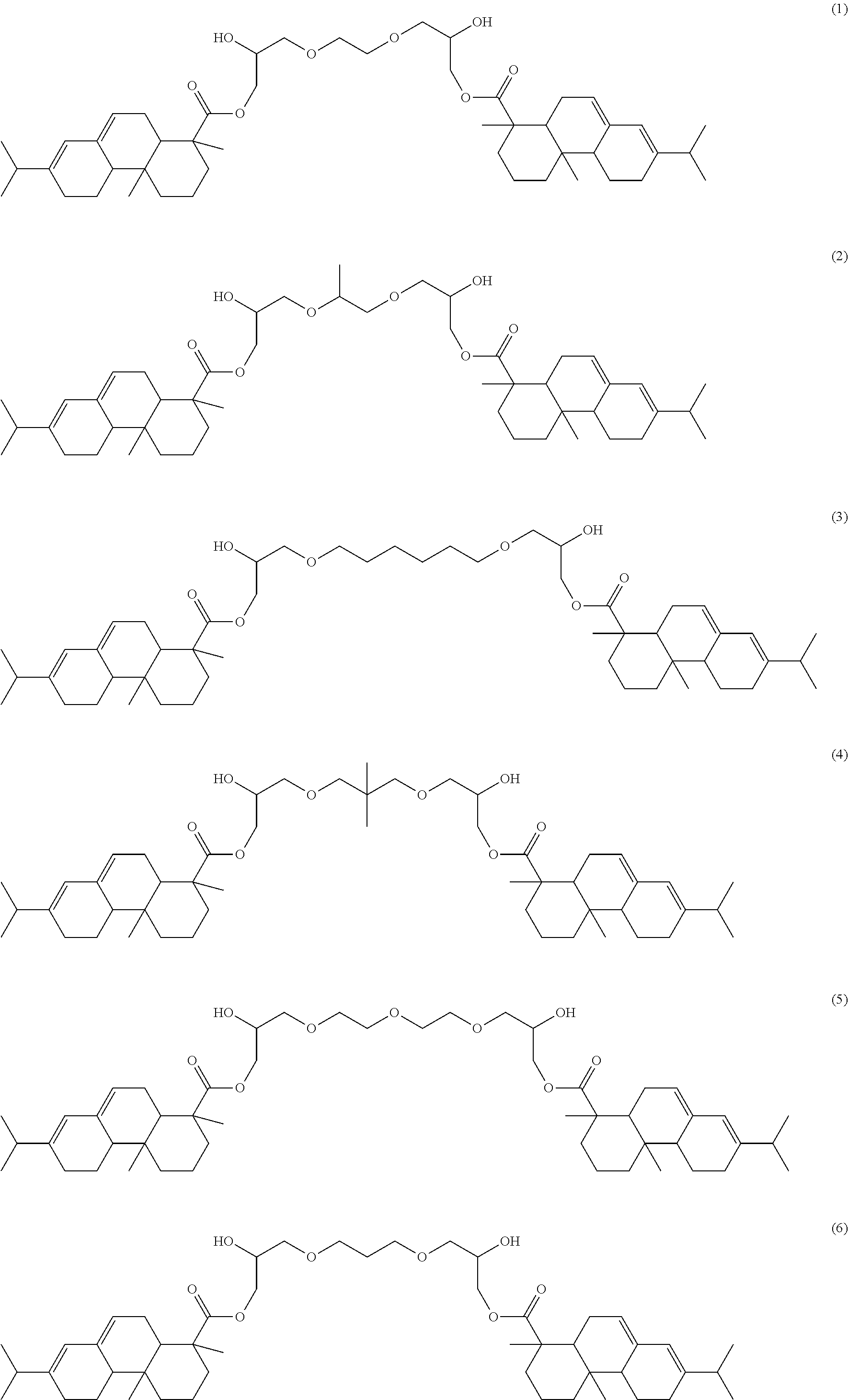

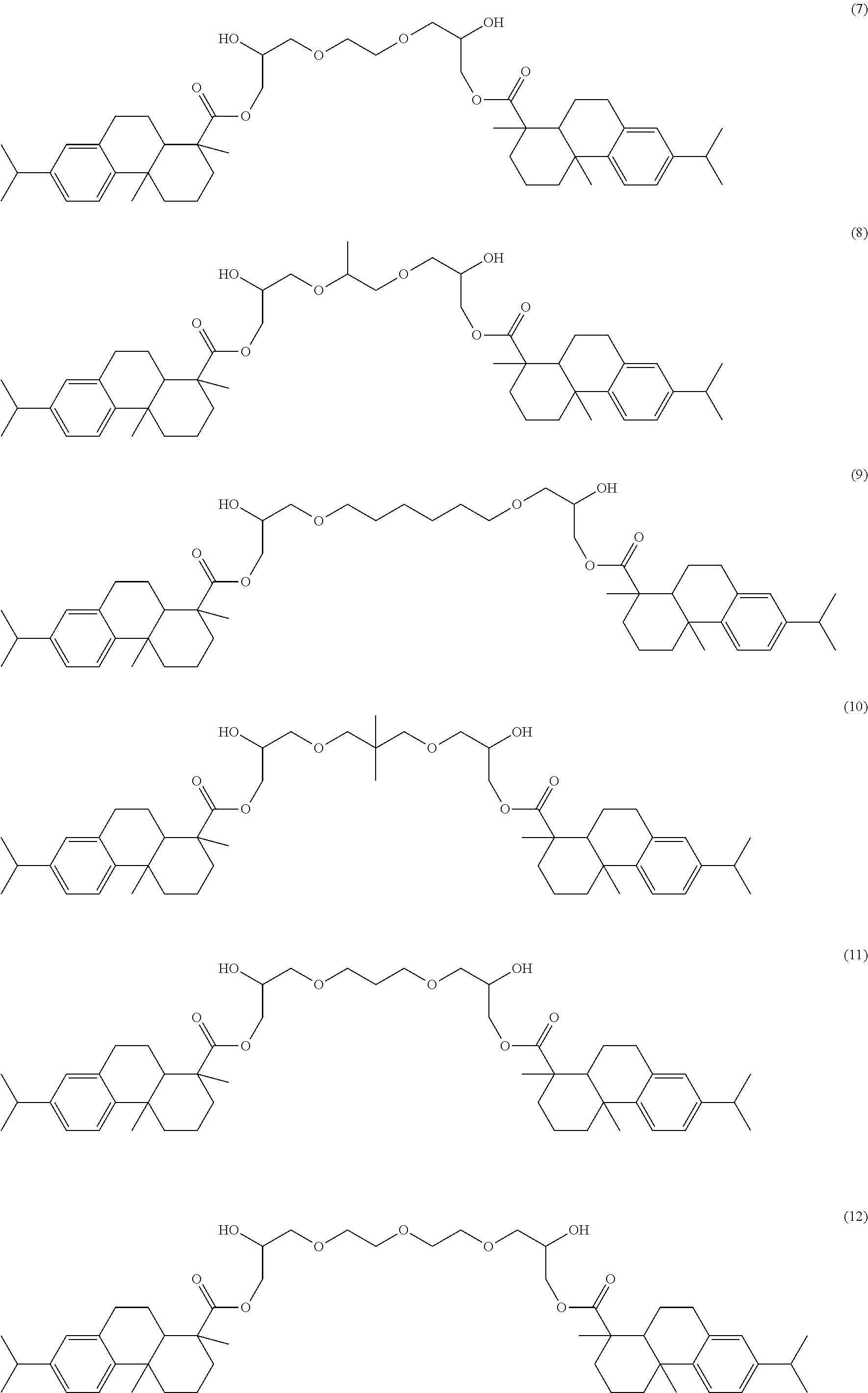

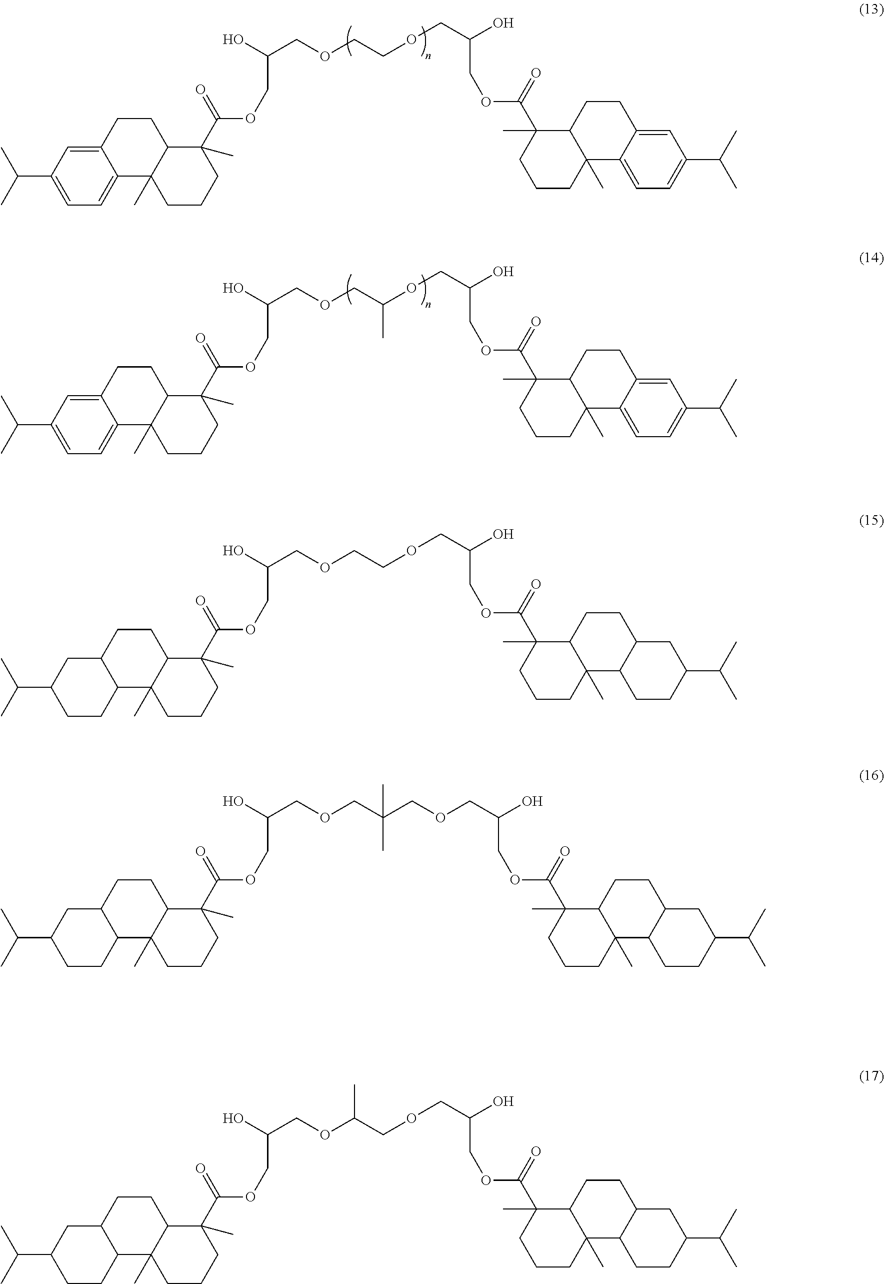

Moreover, in the exemplary compounds of the above specific rosin diol, n represents an integer of 2 or greater.

When synthesizing a specific polyester resin, the content of the specific rosin diol in the first exemplary embodiment is preferably 5 mol % to 60 mol % in the entire polyol components, more preferably 5 mol % to 40 mol %, even more preferably 10 mol % to 35 mol % from the viewpoint of satisfying both the fixability and the electrostatic property.

### [(C) Chain-Like Aliphatic Polyol]

Subsequently, (C) a chain-like aliphatic polyol which is one of the polyol components used for obtaining the specific polyester resin will be described.

In the first exemplary embodiment, in order to obtain the specific polyester resin, (C) the chain-like aliphatic polyol different from (B) the specific rosin diol described above is used in combination.

(C) The chain-like aliphatic polyol refers to compounds in which a plurality of alcoholic hydroxyl groups is linked through chain-like aliphatic groups. Among these, aliphatic diol in which two alcoholic hydroxyl groups are linked through a chain-like aliphatic group is preferable.

As the chain-like aliphatic group, a chain-like alkylene group is preferable, and may have a substituent such as an alkyl group. In particular, the chain-like aliphatic group is preferably a chain-like alkylene group which includes a carbon atom in a substituent and has the total carbon number of 5 or less.

Examples of the aliphatic diol include ethylene glycol, 1,2-propanediol, 1,3-propanediol, 1,2-butanediol, 1,3-butanediol, 1,4-butanediol, 2,3-butanediol, 1,4-butene diol, 2-methyl-1,3-propanediol, 1,5-pentanediol, neopentyl glycol, 2-ethyl-2-methyl propane-1,3-diol, 2-butyl-2-ethylpropane-1,3-diol, 1,6-hexanediol, 3-methyl-1,5-pentanediol, 2-ethyl-1,3-hexanediol, 2,4-dimethyl-1,5-pentanediol, 2,2,4-trimethyl-1,3-pentanediol, 1,7-heptanediol, 1,8-octanediol, 1,9-nonanediol, 1,10-decanediol, 3-hydroxy-2,2-dimethylpropyl-3-hydroxy-2,2-dimethyl propanoate, diethylene glycol, triethylene glycol, polyethylene glycol, dipropylene glycol, and polypropylene glycol.

These aliphatic diols may be used alone or two or more kinds may be used in combination.

Among the above aliphatic diols, from the viewpoint of further improving the low temperature fixability of a toner when applied to the toner, ethylene glycol, 1,2-propanediol, 1,3-propanediol, and neopentyl glycol are preferable.

When synthesizing a specific polyester resin, the content of (C) the chain-like aliphatic polyol is preferably 10 mol % to 95 mol % in polyol components, more preferably 15 mol % to 90 mol % from the viewpoint of satisfying both the fixability and the electrostatic property when applied to a toner.

The specific polyester resin according to the first exemplary embodiment is a polycondensate in which the total amount of (B) the polyol represented by the general formula (1) and (C) the chain-like aliphatic polyol is 60 mol % to 100 mol % in the entire alcohol components (preferably, 70 mol % to 100 mol %, and more preferably 80 mol % to 100 mol %).

When the content ratio is the same as the above, a polyester resin which can improve the low temperature fixability of a toner when applied to the toner can be obtained.

Furthermore, the specific polyester resin according to the first exemplary embodiment is a polycondensate in which the molar ratio [(B)/(C)] of (B) the polyol represented by the following general formula (1) to (C) the chain-like aliphatic polyol is 0.1 to 1.0 (preferably, 0.2 to 0.5).

When the content ratio is the same as the above, a polyester resin which can improve the low temperature fixability of a toner when applied to the toner can be obtained.

### [(D) Other Polyol]

When obtaining the specific polyester resin according to the first exemplary embodiment, other polyols may be used as one of polyol components, other than (B) the polyol represented by the following general formula (1) and (C) the chain-like aliphatic polyol.

As other polyols, etherified diphenol can be preferably exemplified.

The etherified diphenol is diol obtained by an addition reaction of bisphenol A and alkylene oxide, as examples of the alkylene oxide, ethylene oxide and propylene oxide can be exemplified, and the average addition molar number of the alkylene oxide is preferably 2 moles to 16 moles with respect to 1 mole of bisphenol A.

The specific polyester resin is a polycondensate obtained by polycondensation known in the related art using (A) the polycarboxylic acid component, (B) the polyol represented by the following general formula (1), (C) the chain-like aliphatic polyol, and if necessary, (D) other polyol components as raw materials.

As the reaction method, any one of a transesterification reaction or a direct esterification reaction can be applied. In addition, the polycondensation may also be promoted by a method in which the reaction temperature is increased by applying pressure, a reduced pressure method, or a method in which an inert gas is flowed at atmospheric pressure. The above reaction may also be promoted by using catalysts known in the related art such as at least one compound of a metal selected from antimony, titanium, tin, zinc, aluminum, manganese, and germanium. The added amount of these reaction catalysts is preferably 0.01 parts by mass to 1.5 parts by mass, and more preferably 0.05 parts by mass to 1.0 parts by mass with respect to 100 parts by mass of the total amount of the acid component and the alcohol component. The reaction temperature is preferably 180° C. to 300° C.

Rosin which is a source of a rosin ester group contained in the specific rosin diol has a bulky structure and high hydrophobicity, and thus, the specific polyester resin including the rosin ester group hardly contains water. In addition, in the structure of the specific polyester resin, a hydroxyl group or a carboxyl group are present only at the terminals of the resin molecule, and thus, it is possible to increase the amount of the rosin ester group in the resin without increasing the amount of hydroxyl group or a carboxyl group which may adversely affect the electrostatic property of a toner. Furthermore, in a case where the specific rosin diol is obtained by a reaction of rosin and a bifunctional epoxy compound, the reactivity of the ring opening reaction of the epoxy, group which occurs between the epoxy groups in the bifunctional epoxy compound and the carboxyl groups in the rosin is higher than that of the esterification reaction which occurs between the alcohol component and the rosin, and thus, unreacted rosin in the specific polyester resin is less likely to remain.

Hereinafter, one example of the synthesis scheme of the specific polyester resin will be shown. In the following synthesis scheme, the specific rosin diol is synthesized by a reaction of a bifunctional epoxy compound and rosin, and a polycondensate of the specific polyester resin is synthesized by a dehydrative polycondensation reaction of this specific rosin diol and dicarboxylic acid. Moreover, among structural formulas showing the specific polyester resin, the portion surrounded by a dotted line corresponds to the rosin ester group.

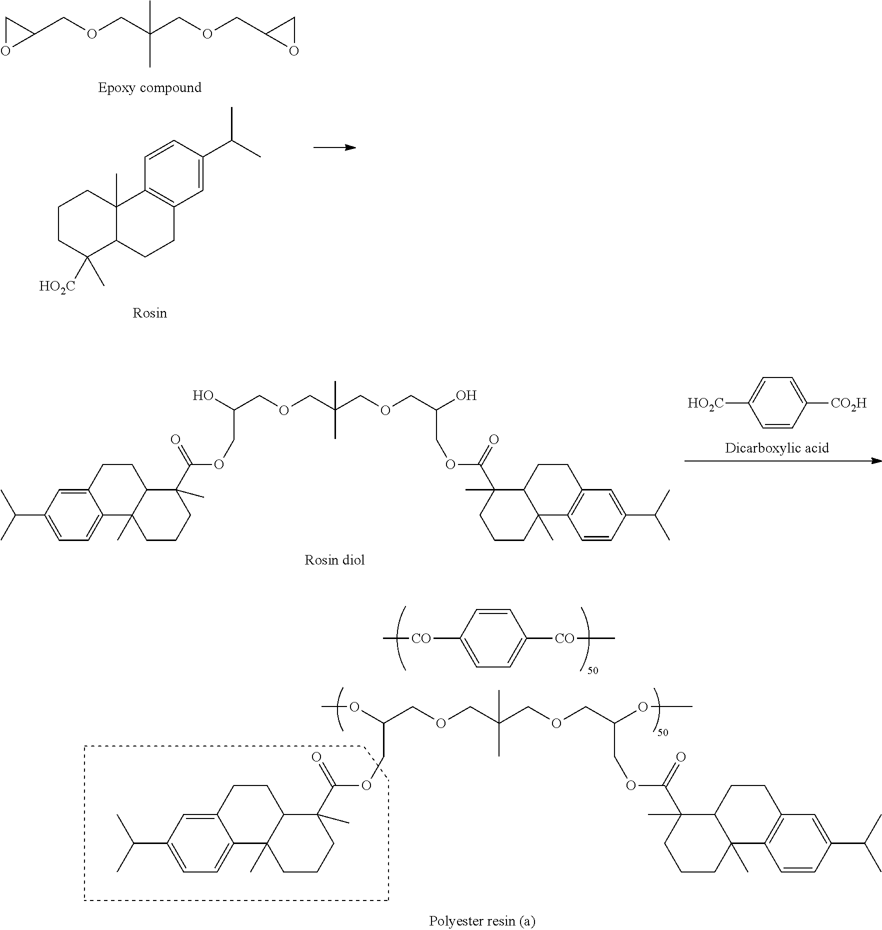

Moreover, when the polycondensate of the specific polyester resin is hydrolyzed, the polycondensate is decomposed into the following monomers. The specific polyester resin is a 1:1 condensate of polycarboxylic acid and polyol, and thus, the constituents of the resin are estimated from the decomposition products.

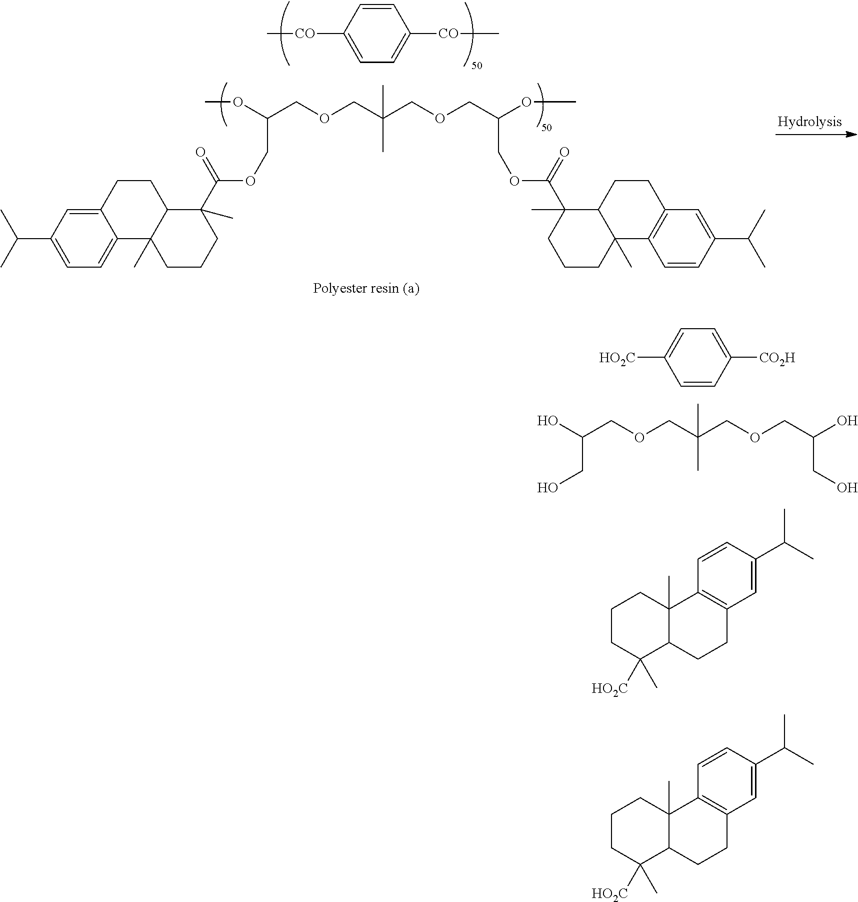

### [Physical Properties of Specific Polyester Resin]

From the viewpoint of fixability of a toner, preserving property, and durability when applied to the toner, the softening temperature of the specific polyester resin according to the first exemplary embodiment is preferably 80° C. to 160° C., and more preferably 90° C. to 150° C.

The glass transition temperature of the specific polyester resin according to the embodiment is preferably 35° C. to 80° C., and more preferably 40° C. or higher and 70° C. from the viewpoint of fixability of a toner, preserving property, and durability in a case of being used as a binding resin of a toner.

It is possible to easily adjust the softening temperature and the glass transition temperature by adjusting a raw material monomer composition, a polymerization initiator, a molecular weight, or the amount of catalyst, or suitably selecting the reaction conditions.

In addition, the softening temperature and the glass transition temperature of the specific polyester resin can be determined by the method described in Example.

The acid value of the specific polyester resin according to the first exemplary embodiment is preferably 1 mg KOH/g to 50 mg KOH/g, and more preferably 3 mg KOH/g to 30 mg KOH/g from the viewpoint of the electrostatic property of a toner when applied to the toner.

In addition, from the viewpoint of durability of a toner and hot offset resistance when applied to the toner, the weight average molecular weight (Mw) of the specific polyester resin according to the first exemplary embodiment is preferably 4,000 to 1,000,000, more preferably 7,000 to 300,000, and even more preferably 20,000 to 90,000.

Moreover, the acid value, the weight average molecular weight Mw, and the number average molecular weight Mn of the specific polyester resin can be determined by the method described in Example.

Moreover, the specific polyester resin according to the first exemplary embodiment may be modified polyester. Examples of the modified polyester include polyester grafted or blocked by phenol, urethane, or epoxy, according to the methods disclosed in JP-A-11-133668, JP-A-10-239903, and JP-A-8-20636.

### <Polyester Resin for Toner>

The polyester resin for a toner according to the second exemplary embodiment is a polycondensate of (A1) a polycarboxylic acid component including aliphatic polycarboxylic acid and (B1) a polyol component which includes the polyol (hereinafter, also referred to as “specific rosin diol”) represented by the following general formula (2) of 50 mol % or less with respect to the entire polyol components, in which the carbon number C1 which a divalent group which L¹ in the polyol represented by the following general formula (1) represents has and the carbon number C2 which the aliphatic polycarboxylic acid has satisfy the following relational formula (A).

Relational formula (A):

0.5<C1/C2≦3.

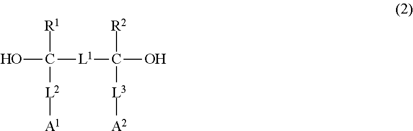

In the general formula (2), each of R¹ and R² independently represents a hydrogen atom or a methyl group. L¹ represents a chain-like alkylene group that may have a substituent, or a divalent group obtained by combining the chain-like alkylene group and an ester group or an ether group, and each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, a divalent group obtained by combination thereof, and L¹ and L² or L¹ and L³ may form a ring. Each of A1 and A2 represents a rosin ester group.

In the polyester resin which has rosin diol as polycondensation components, the rosin diol regularly has a bulky rosin structure on the side chain, and thus, there is a tendency that the cohesive force between molecules is weak, and the polyester resin becomes brittle.

For this reason, an electrostatic charge image developing toner (hereinafter, simply referred to as “toner” in some cases) to which the resin which is a polycondensate of rosin diol and aromatic polycarboxylic acid is applied is likely to be destructed by a mechanical load (for example, load caused by stirring with a carrier) due to a collision or the like.

Therefore, when the polyester resin for a toner according to the second exemplary embodiment which is a polycondensate of a polycarboxylic acid component and a polyol component, in which the carbon numbers C1 and C2 satisfy the relational formula (A), is applied to a toner and a mechanical load due to a collision or the like is imparted, destruction of the toner is suppressed.

The reason for this is not clear, but is considered to be as follows.

The toner including the polyester resin is likely to be destructed in a case where the polyester resin has brittleness. It is considered that the brittleness of the polyester resin is controlled, for example, by entanglement between the resins, flexibility of the resin chain, and the presence of the portion crystallized.

Here, in the polyester resin for a toner according to the second exemplary embodiment, since aliphatic polycarboxylic acid is included in the polycarboxylic acid component which is a polycondensation component, when the polycarboxylic acid component and a polyol component including specific rosin diol are polycondensated, a resin having a structure of aliphatic polycarboxylic acid on the main chain to which two bulky side chain rosins are linked is formed.

Thus, it is considered that in the polyester resin for a toner according to the second exemplary embodiment, the main chain has a flexible structure, and thus flexibility of the resin chain is improved, and entanglement between the resins is suppressed.

Then, it is considered that since the linked portion of the rosin the bulky rosin structure is flexible, in the polyester resin for a toner according to the second exemplary embodiment, increasing in the excluded volume of the resin due to the rosin structure is suppressed, and thus, the cohesive force between resins is improved, and brittleness is weakened.

In particular, the polyester resin for a toner according to the second exemplary embodiment is a polyester resin in which the ratio (C1/C2) of the carbon number C1 which a divalent group which L¹ in the specific rosin diol represents has and the carbon number C2 which the aliphatic polycarboxylic acid has is greater than 0.5 and less than 2, that is, a polyester resin having a aliphatic chain with small difference in the carbon number on the main chain. Thus, it is considered that though the polyester resin has a bulky structure such as a rosin attached on the side chain, the cohesive force of the entire resin tends to be improved, and brittleness is weakened.

It is considered that this is because the carbon numbers C1 and C2 satisfy the above relational formula, and by this, flexibility is improved, and by disposing the ester groups with approximately constant intervals, the effect of the cohesive force due to a hydrogen bonding between resins can be obtained.

Moreover, in a case where plural kinds of the specific rosin diol and the aliphatic polycarboxylic acid are used, the ratio (C1/C2) is within the above range in all combinations of each specific rosin diol and each aliphatic polycarboxylic acid.

From the above, the polyester resin for a toner according to the second exemplary embodiment suppresses the destruction of the toner.

Moreover, it is considered that the polyester resin for a toner according to the second exemplary embodiment suppresses the contamination of the image background portion and decrease in the transfer property by suppressing the destruction of the toner.

Here, the ratio (C1/C2) of the carbon number C1 which a divalent group which L¹ in the specific rosin diol represents has and the carbon number C2 which the aliphatic polycarboxylic acid has is preferably 0.5 to 2.5, and more preferably 1.0 to and 2.0.

The carbon number C1 which a divalent group which L¹ represents has is preferably 3 to 15, more preferably 3 to 10, and even more preferably 4 to 10.

In addition, the carbon number C2 which the aliphatic polycarboxylic acid has is preferably 2 to 8, and more preferably 4 to 6.

Moreover, the carbon number C1 which a divalent group which L¹ in the specific rosin diol represents has means the total carbon number of a divalent group which L¹ represents, and in a case where the divalent group represented by L¹, for example, has a branched chain or a substituent including carbon atoms, the carbon number C1 means the total number of the carbon number of the branched chain, or the carbon number including carbons of the substituent.

In addition, the carbon number C2 including the aliphatic polycarboxylic acid also means the total carbon number (that is, the total carbon number also including carbons in a carboxylic group of the polycarboxylic acid) of the aliphatic polycarboxylic acid as the same manner of the above carbon number C2, and in a case where the aliphatic polycarboxylic acid, for example, has a branched chain or a substituent including carbon atoms, the carbon number C2 means the total number of the carbon number of the branched chain, or the carbon number including carbons of the substituent.

Hereinafter, monomer components to obtain the polyester resin for toner (hereinafter, referred to as “specific polyester resin” (according to the second exemplary embodiment) in some case) according to the second exemplary embodiment, that is, the polycarboxylic acid component and the polyol component will be described in detail.

### [(A1) Polycarboxylic Acid]

The polycarboxylic acid component used for obtaining the specific polyester resin will be described.

The polycarboxylic acid component includes aliphatic polycarboxylic acid.

The polycarboxylic acid component, as described below, may include at least one selected from a group consisting of aliphatic polycarboxylic acid including an aliphatic structure.

In addition, the polycarboxylic acid component preferably includes at least one selected from a group consisting of aliphatic polycarboxylic acid including the aliphatic structure as described below, and at least one selected from a group consisting of aliphatic polycarboxylic acid including the aliphatic structure as described below from the viewpoint of further improving the low temperature fixability of the toner.

As the aliphatic polycarboxylic acid, aliphatic dicarboxylic acid is preferable.

Specific examples of the aliphatic dicarboxylic acid include aromatic aliphatic dicarboxylic acids such as oxalic acid, malonic acid, maleic acid, fumaric acid, citraconic acid, itaconic acid, glutaconic acid, succinic acid, glutaric acid, adipic acid, sebacic acid, azelaic acid, dimer acid, alkyl succinic acid having 1 to 20 carbon atoms with a branched chain, and alkenylene succinic acid having an alkenyl group having 1 to 20 carbon atoms with a branched chain; anhydrides of the acids thereof; and alkyl (having 1 to 3 carbon atoms) esters of the acids thereof.

These aliphatic dicarboxylic acids may be used alone, or two or more kinds thereof may be used in combination.

The aliphatic polycarboxylic acid is preferably aliphatic polycarboxylic acid having the carbon number C2 of 4 to 6, and aliphatic dicarboxylic acid having the carbon number C2 of 4 to 6, from the viewpoint of suppressing partial crystallization of the place at which a chain length of the aliphatic structure is long, occurrence of a crystal domain in a polycondensate, and the destruction of the toner, when polycondensated.

As the specific examples of the aliphatic dicarboxylic acid having the carbon number C2 of 4 to 6, succinic acid, adipidic acid, glutaric acid, and fumaric acid are preferable, succinic acid and adipidic acid are more preferable, and succinic acid is particularly preferable.

The aliphatic polycarboxylic acid is preferably included in 1 mol % to 30 mol % with respect to the entire polycarboxylic acid components.

It is considered that when the aliphatic polycarboxylic acid is included in the above range with respect to the entire polycarboxylic acid components, when polycondensated, a place at which a chain length of the aliphatic structure is long is partially crystallized, occurrence of a crystal domain in a polycondensate is suppressed, and the destruction of the toner is suppressed.

The aliphatic polycarboxylic acid is more preferably included in 3 mol % to 25 mol %, and even more preferably included in 4 mol % to 20 mol % with respect to the entire polycarboxylic acid components.

As the aromatic polycarboxylic acid, aromatic dicarboxylic acid is preferable.

Specific examples of the aromatic dicarboxylic acid include aromatic dicarboxylic acids such as phthalic acid, isophthalic acid, terephthalic acid, 1,4-naphthalene dicarboxylic acid, and 2,6-naphthalene dicarboxylic acid; and anhydrides of these acids, and alkyl (having carbon number of 1 to 3) ester of these acids.

Among these, from the viewpoint of durability, fixability of a toner, and dispersibility of a colorant when applied to the toner, and from the viewpoint of availability, as the aromatic polycarboxylic acid, aromatic dicarboxylic acids such as isophthalic acid and terephthalic acid are preferable.

These aromatic dicarboxylic acids may be used alone, or two or more kinds thereof may be used in combination.

Moreover, within a range not impairing the effect of the embodiment, as the polycarboxylic acid component, tri- or higher aromatic carboxylic acids may also be used.

Examples of the tri- or higher carboxylic acids include trimellitic acid, pyromellitic acid, naphthalene tricarboxylic acid, benzophenone tetracarboxylic acid, biphenyl tetracarboxylic acid, and anhydrides thereof, and these may be used alone, or two or more kinds thereof may be used in combination.

As the tri- or higher aromatic carboxylic acids, trimellitic anhydride is preferable from the viewpoint of availability or reactivity.

### [(B1) Polyol Component]

Hereinafter, the polyol component will be described.

The polyol component includes the specific rosin diol and polyol other than the specific rosin diol.

The polyol component includes the specific rosin diol of 50 mol % or less with respect to the entire polyol components.

The specific rosin diol is preferably contained in 2 mol % to 40 mol %, and more preferably 4 mol % to 15 mol % with respect to the entire polyol components form the viewpoint of achieving a balance between the fixability and the electrostatic property.

### (Specific Rosin Diol)

Next, the specific rosin diol which is one of the polyol components used for obtaining the specific polyester resin will be described.

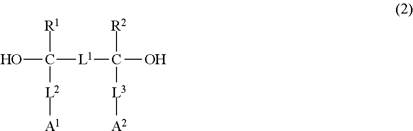

In the above general formula (2), each of R¹ and R² independently represents hydrogen or a methyl group. L¹ represents a chain-like alkylene group that may have a substituent, or a divalent group obtained by combining the chain-like alkylene group and an ester group or an ether group, and each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, a divalent group obtained by combination thereof, and L¹ and L² or L¹ and L³ may form a ring. Each of A¹ and A² represents a rosin ester group.

Here, the rosin ester group represents a residue excluding hydrogen atoms from a carboxyl group included in the rosin.

Examples of the chain-like alkylene group represented by L¹ include a chain-like alkylene group having a carbon number of 1 to 15, and among these, a chain-like alkylene group having a methyl group as a substituent is preferable.

As L¹, divalent groups obtained by combining the chain-like alkylene group and an ester group or an ether group is preferable. Among these, as the L¹, divalent groups obtained by combining a methylene group, an ether group, and an alkylene group having a total carbon number of 4 to 10 are preferable, divalent groups obtained by combining a methylene group, an ether group, an alkylene group having a total carbon number of 2 to 5 are more preferable, and divalent groups shown below are particularly preferable.

Among divalent groups described below, structures of 1, 2, 3, and 5 are preferable, and structures of 1 and 5 having a methyl group as a substituent are particularly preferable.

Moreover, n represents an integer of 2 or greater.

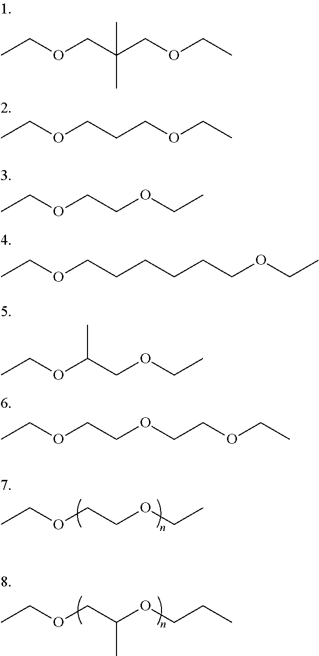

Examples of the chain-like alkylene group represented by the L² and L³ include an alkylene group having a carbon number of 1 to 10.

Examples of the cyclic alkylene group represented by the L² and L³ include a cyclic alkylene group having a carbon number of 3 to 7.

Examples of the arylene group represented by the L² and L³ include a phenylene group, a naphthylene group, and an anthracene group.

L² and L³ is preferably a chain-like alkylene group, more preferably a chain-like alkylene group having a carbon number of 1 to 2.

As the example of the substituent introduced into the chain-like alkylene group, the cyclic alkylene group, or the arylene group, an alkyl group having a carbon number of 1 to 8, and an aryl group can be exemplified, and a linear, a branched, or a cyclic alkyl group is preferable. Specific examples thereof include a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclopentyl group, a cyclohexyl group, and a phenyl group.

Next, the synthetic method of specific rosin diols will be specifically described.

The specific rosin diol is synthesized by a known method, for example, a reaction of an epoxy compound and rosin.

The epoxy compound which may be used in the second exemplary embodiment is a bifunctional epoxy compound including two epoxy groups in one molecule, and diglycidyl ether of aliphatic diol which is L¹ in the general formula (2) and the like can be exemplified.

In this manner, by synthesizing the specific rosin diol using a polyfunctional epoxy compound, for example, a toner having more excellent electrostatic property can be obtained from the polyester resin including a repeating unit derived from such a specific rosin diol. This is because the reactivity of the epoxy compound is higher than the reactivities of other general-purpose functional alcohols, and thus, carboxylic acid with a low reactivity having rosin is efficiently reacted. As a result, the reverse reaction or the side reaction is also suppressed.

This is because the reactivity of the epoxy compound is higher than the reactivities of other general-purpose functional alcohols, and thus, carboxylic acid with a low reactivity having rosin is efficiently reacted. As a result, the reverse reaction or the side reaction is also suppressed.

As representative examples of the diglycidyl ether of aliphatic diol, diglycidyl ethers such as ethylene glycol, 1,2-propanediol, 1,3-propanediol, 1,4-butanediol, 1,5-pentanediol, 1,6-hexanediol, neopentyl glycol, 1,9-nonanediol, diethylene glycol, triethylene glycol, polyethylene glycol, polypropylene glycol, and polytetramethylene glycol can be exemplified.

Among these, diglycidyl ethers such as ethylene glycol, 1,2-propanediol, 1,3-propanediol, 1,6-hexanediol, neopentyl glycol, and diethylene glycol can be preferably exemplified.

For example, the epoxy group-containing compound is obtained by a reaction of a diol component and epihalohydrin.

A reaction of rosin and a bifunctional epoxy compound is proceeded mainly by a ring opening reaction of a carboxyl group of rosin and an epoxy group of a bifunctional epoxy compound. Here, it is preferable that the reaction temperature be equal to or more than the melting temperatures of both constituents, or be a temperature at which a mixing is performed, and specifically, a range of 60° C. to 200° C. is general. During the reaction, a catalyst for promoting the ring opening reaction of the epoxy group may be added.

Examples of the catalyst include amines such as ethylenediamine, trimethylamine, and 2-methyl imidazole, quaternary ammonium salts such as, triethyl ammonium bromide, triethyl ammonium chloride, and butyltrimethyl ammonium chloride, and triphenylphosphine.

The reaction can be performed in various methods. For example, generally, in a case of a four-batch type, rosin and a bifunctional epoxy compound at a desired ratio are put into a flask having a heat function equipped with a cooling tube, a stirrer, an inert gas inlet, a thermometer, and the like, and the mixture is heated and melted. The reaction product is sampled, and by this, the progress of the reaction is checked. The progress of the reaction is confirmed by a decrease in an acid value, and for example, the reaction is finished at a stoichiometric reaction ending point or at the time when the reaction reaches the vicinity of the ending point.

As the reaction ratio of rosin and the bifunctional epoxy compound, which is not particularly limited, rosin is preferably reacted in a range of 1.5 moles to 2.5 moles with respect to the bifunctional epoxy compound of 1 mole.

Next, the rosin in a specific rosin diol represented by the general formula (2) will be described.

The rosin in a specific rosin diol represented by the general formula (2) is same as the rosin in a specific rosin diol represented by the general formula (1) according to the first exemplary embodiment described above.

Exemplary compounds of the specific rosin diol are shown below, but the second exemplary embodiment is not limited thereto.

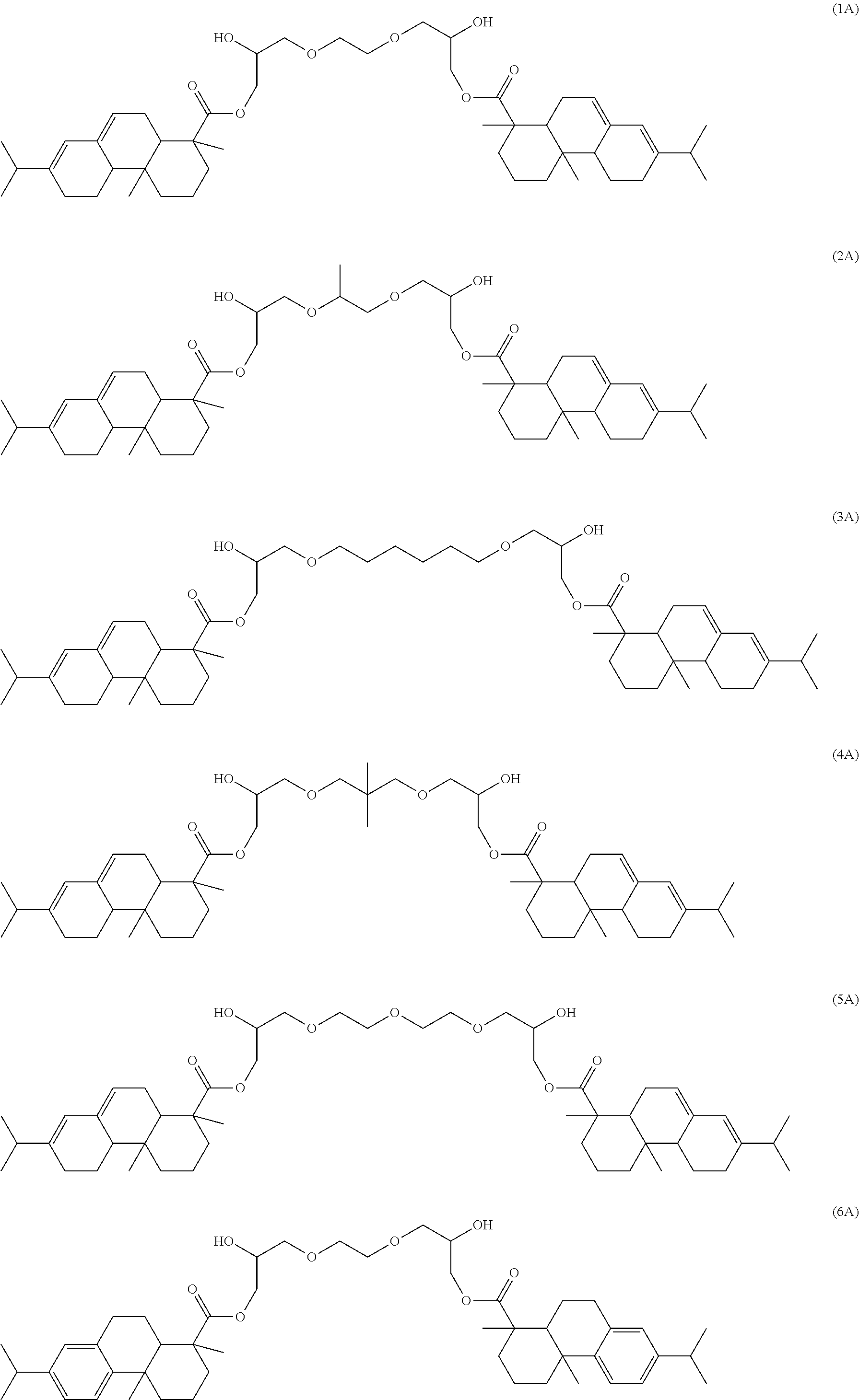

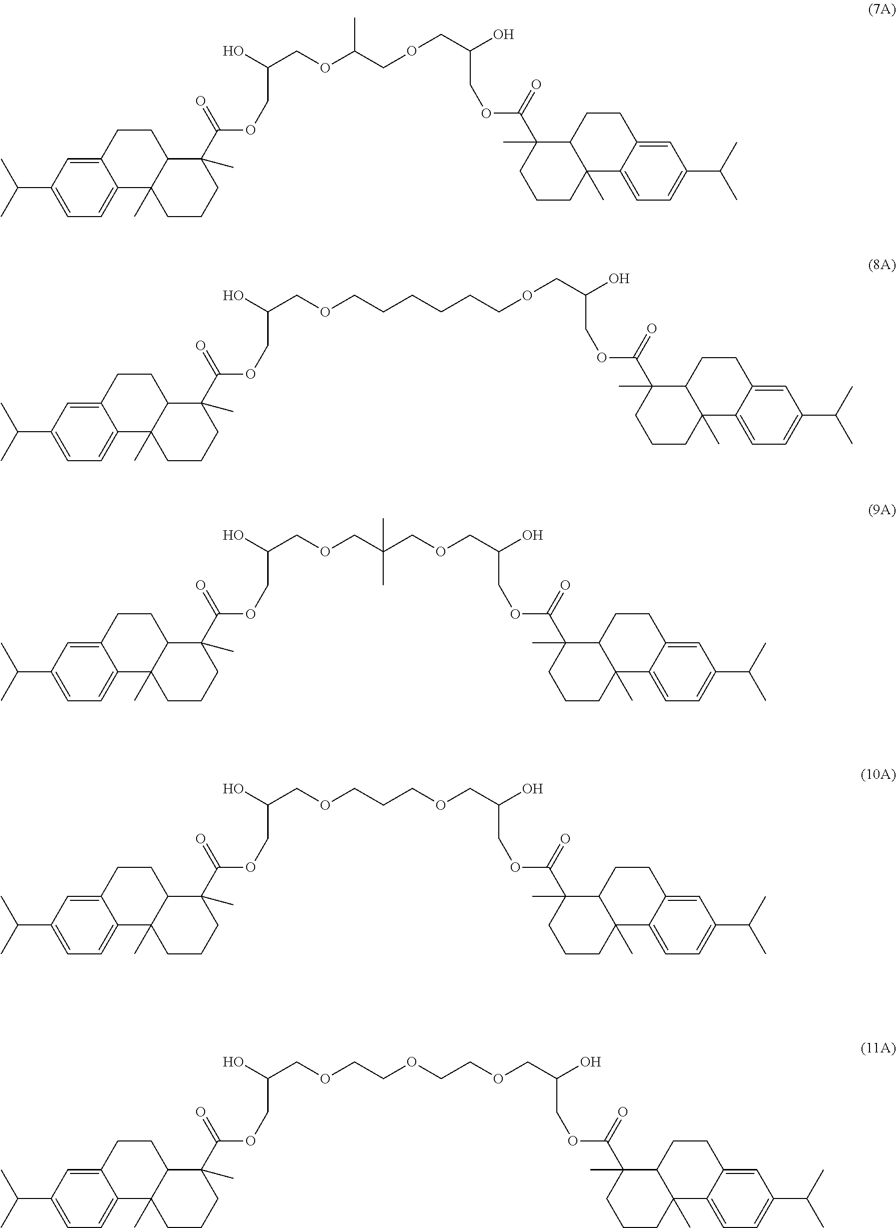

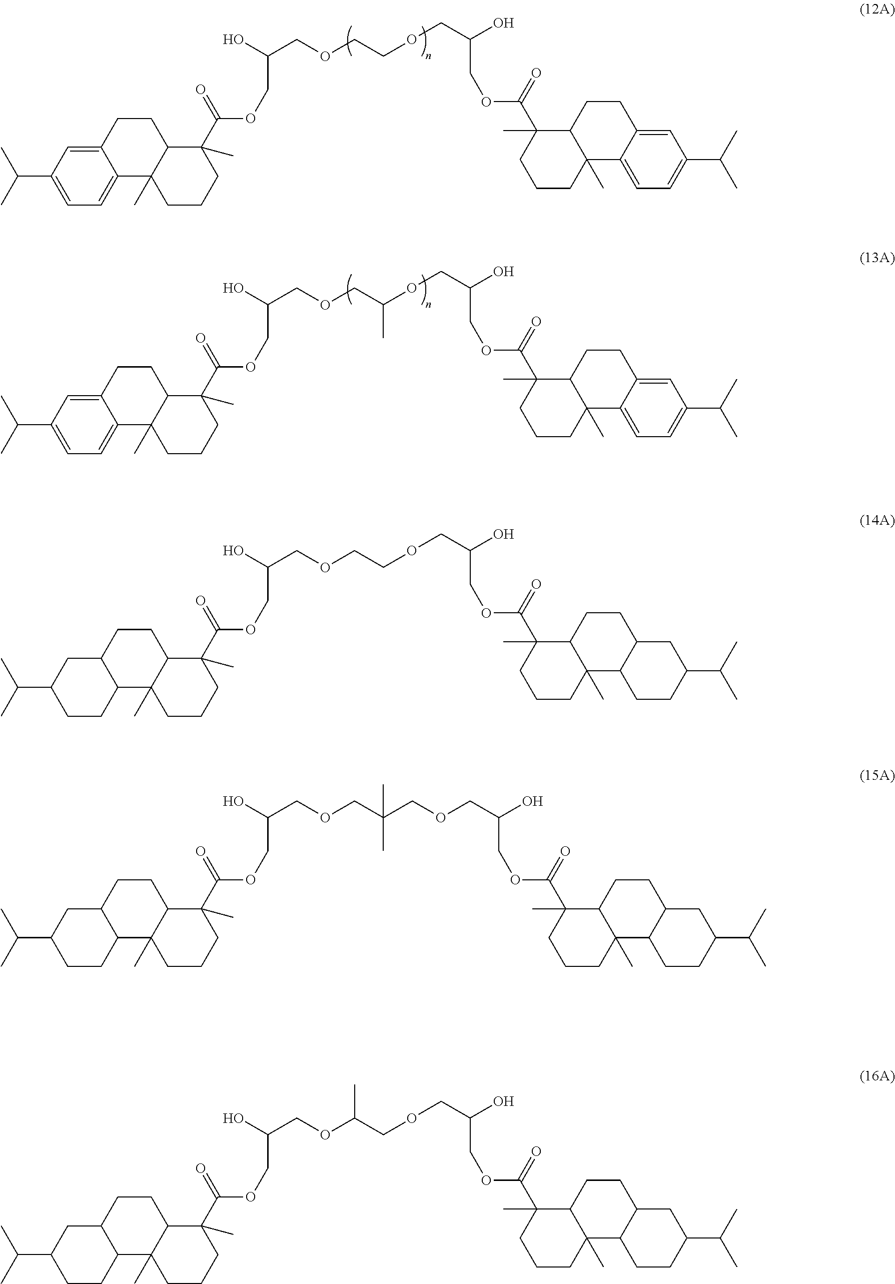

Moreover, in the exemplary compounds of the above specific rosin diol, n represents an integer of 1 to 3.

### (Other Polyol)

In the second exemplary embodiment, as the polyol component, the specific rosin diol and polyol (other polyols) other than the specific rosin diol are used in combination.

Examples of the other polyols include aliphatic diol and aromatic diol.

Specific examples of the aliphatic diol include ethylene glycol, 1,2-propanediol, 1,3-propanediol, 1,2-butanediol, 1,3-butanediol, 1,4-butanediol, 2,3-butanediol, 1,4-butene diol, 2-methyl-1,3-propanediol, 1,5-pentanediol, neopentyl glycol, 2-ethyl-2-methyl propane-1,3-diol, 2-butyl-2-ethylpropane-1,3-diol, 1,6-hexanediol, 3-methyl-1,5-pentanediol, 2-ethyl-1,3-hexanediol, 2,4-dimethyl-1,5-pentanediol, 2,2,4-trimethyl-1,3-pentanediol, 1,7-heptanediol, 1,8-octanediol, 1,9-nonanediol, 1,10-decanediol, 1,11-undecanediol, 1,12-dodecanediol, 1,3-tridecanediol, 1,14-tetradecanediol, 1,18-octadecanediol, 1,14-eicosane decanediol, dimerdiol, 3-hydroxy-2,2-dimethylpropyl-3-hydroxy-2,2-dimethyl propanoate, diethylene glycol, triethylene glycol, polyethylene glycol, dipropylene glycol, and polypropylene glycol, but the embodiment is not limited thereto.

Examples of the aromatic diol include bisphenol A ethylene oxide adduct, bisphenol A propylene oxide adduct, and bisphenol A butylene oxide adduct, and the embodiment is not limited thereto.

These may be used alone or two or more kinds may be used in combination.

In addition, in the second exemplary embodiment, etherified diphenol may be used together with the aliphatic diol. The etherified diphenol is diol obtained by an addition reaction of bisphenol A and alkylene oxide, as examples of the alkylene oxide, ethylene oxide and propylene oxide can be exemplified, and the average addition molar number of the alkylene oxide is preferably 2 moles to 16 moles with respect to 1 mole of bisphenol A.

The other polyols included in the polyol component preferably has the carbon number of 5 or less, and more preferably has the total carbon number of 4 or less from the viewpoint of suppressing partial crystallization of the place at which a chain length of the aliphatic structure is long in a case where a polycondensate is formed.

In addition, as the other polyols, aliphatic diol is preferable.

Here, the total carbon number of the other polyols, for example, in a case where the other polyols have side chains or substituents, represents the carbon number also including carbons of the side chain or the substituent.

### (Synthesis of Specific Polyester Resin)

The specific polyester resin is obtained by polycondensation known in the related art using a polycarboxylic acid component including aliphatic polyvalent carboxylic acid and a polyol component including rosin diol of 50 mol % or less with respect to the entire polyol components as raw materials.

As the reaction method, any one of a transesterification reaction or a direct esterification reaction can be applied. In addition, the polycondensation may also be promoted by a method in which the reaction temperature is increased by applying pressure, a reduced pressure method, or a method in which an inert gas is flowed at atmospheric pressure. The above reaction may also be promoted by using catalysts known in the related art such as at least one compound of a metal selected from antimony, titanium, tin, zinc, aluminum, manganese, and germanium. The added amount of these reaction catalysts is preferably 0.01 parts by mass to 1.5 parts by mass, and more preferably 0.05 parts by mass to 1.0 parts by mass with respect to 100 parts by mass of the total amount of the acid component and the alcohol component. The reaction temperature is preferably 180° C. to 300° C.

Rosin which is a source of a rosin ester group contained in the specific rosin diol has a bulky structure and high hydrophobicity, and thus, the specific polyester resin including the rosin ester group hardly contains water. In addition, in the structure of the specific polyester resin, a hydroxyl group or a carboxyl group are present only at the terminals of the resin molecule, and thus, it is possible to increase the amount of the rosin ester group in the resin without increasing the amount of hydroxyl group or a carboxyl group which may adversely affect the electrostatic property of a toner. Furthermore, in a case where the specific rosin diol is obtained by a reaction of rosin and a bifunctional epoxy compound, the reactivity of the ring opening reaction of the epoxy group which occurs between the epoxy groups in the bifunctional epoxy compound and the carboxyl groups in the rosin is higher than that of the esterification reaction which occurs between the alcohol component and the rosin, and thus, unreacted rosin in the specific polyester resin is less likely to remain.

Hereinafter, one example of the synthesis scheme of the specific polyester resin will be shown. In the following synthesis scheme, the specific rosin diol is synthesized by reacting a bifunctional epoxy compound with rosin, and a polycondensate of the specific polyester resin is synthesized by a dehydrative polycondensation reaction of this specific rosin diol and dicarboxylic acid. Moreover, among structural formulas showing the specific polyester resin, the portion surrounded by a dotted line corresponds to the rosin ester group.

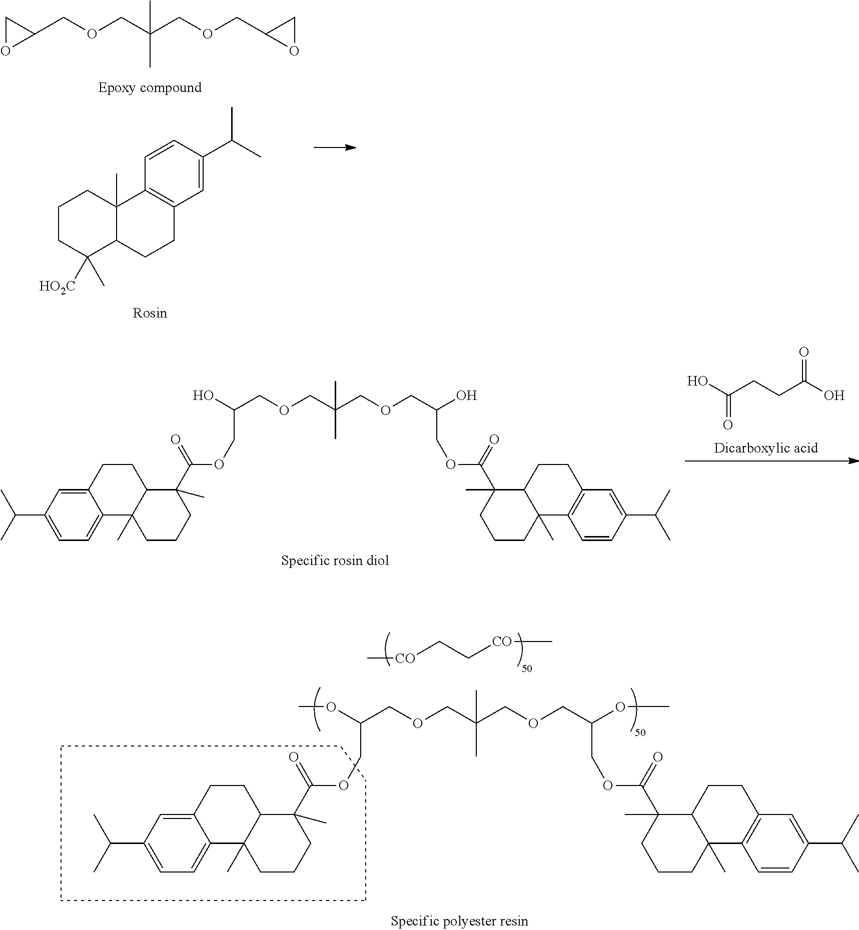

Moreover, when the polycondensate of the specific polyester resin is hydrolyzed, the polycondensate is decomposed into the following monomers. The specific polyester resin is a 1:1 condensate of polycarboxylic acid and polyol, and thus, the constituents of the resin are estimated from the decomposition products.

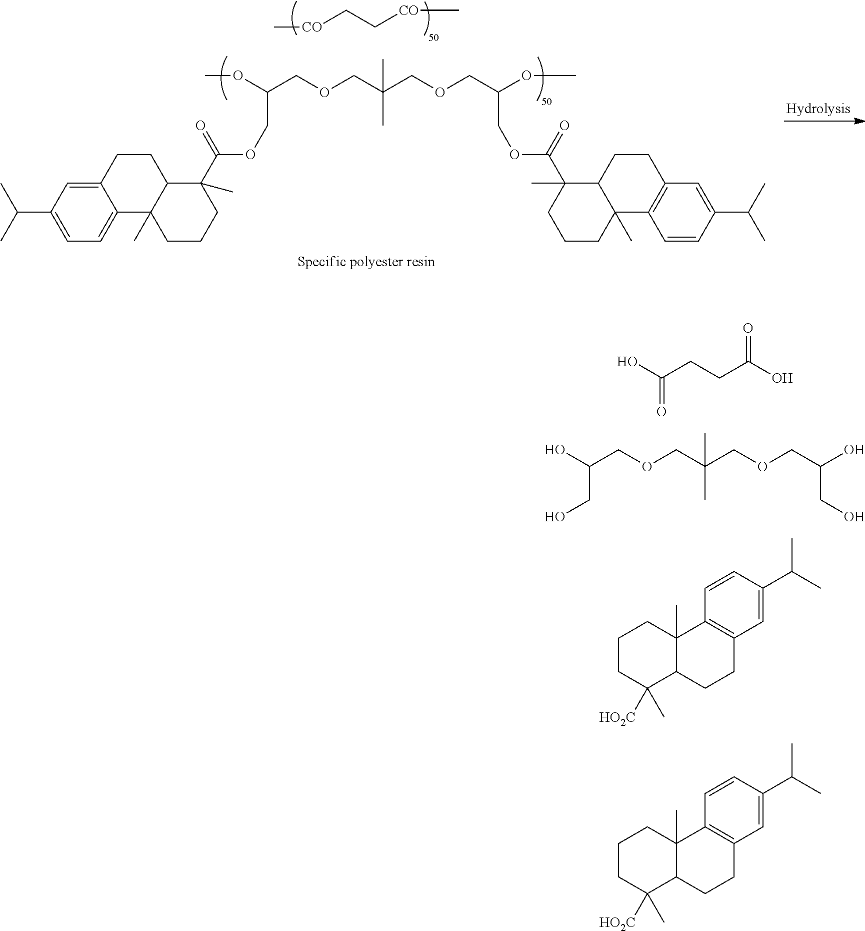

### [Physical Properties of Specific Polyester Resin]

From the viewpoint of fixability of a toner, preserving property, and durability when applied to the toner, the softening temperature of the specific polyester resin according to the second exemplary embodiment is preferably 80° C. to 160° C., and more preferably 90° C. to 150° C.

The glass transition temperature of the specific polyester resin according to the second embodiment is preferably 35° C. to 80° C., and more preferably 40° C. or higher and 70° C. from the viewpoint of fixability of a toner, preserving property, and durability in a case of being used as a binding resin of a toner.

It is possible to easily adjust the softening temperature and the glass transition temperature by adjusting a raw material monomer composition, a polymerization initiator, a molecular weight, or the amount of catalyst, or suitably selecting the reaction conditions.

In addition, the softening temperature and the glass transition temperature of the specific polyester resin can be determined by the method described in Example.

The acid value of the specific polyester resin according to the second exemplary embodiment is preferably 1 mg KOH/g to 50 mg KOH/g, and more preferably 3 mg KOH/g to 30 mg KOH/g from the viewpoint of the electrostatic property of a toner when applied to the toner.

In addition, from the viewpoint of durability of a toner and hot offset resistance when applied to the toner, the weight average molecular weight (Mw) of the specific polyester resin according to the second exemplary embodiment is preferably 4,000 to 1,000,000, more preferably 7,000 to 300,000, and even more preferably 20,000 to 90,000.

Moreover, the acid value, the weight average molecular weight Mw, and the number average molecular weight Mn of the specific polyester resin can be determined by the method described in Example.

Moreover, the specific polyester resin according to the second exemplary embodiment may be modified polyester. Examples of the modified polyester include polyester grafted or blocked by phenol, urethane, or epoxy, according to the methods disclosed in JP-A-11-133668, JP-A-10-239903, and JP-A-8-20636.

### <Toner for Electrostatic Charge Image Development>

A toner for electrostatic charge image development according to the embodiment (hereinafter, referred to as “toner”) contains the specific polyester resin according to the first exemplary embodiment or the second exemplary embodiment as a binder resin, and if necessary, includes a colorant, a release agent, a charge control agent, or an external additive.

Moreover, in the toner according to the embodiment, known binder resins other than the specific polyester resin, for example, a polyester resin different from the specific polyester resin, a vinyl-based resin such as styrene-acrylic resin, an epoxy resin, polycarbonate, or polyurethane may be used in combination within a range not impairing the effect due to the specific polyester resin.

The content of the specific polyester resin in the binder resin constituting a toner is preferably 60% by mass or greater, more preferably 80% by mass or greater, and even more preferably substantially 100% by mass or greater.

### (Colorant)

The colorant may be a dye or a pigment, however, is preferably a pigment from the viewpoint of lightfastness or waterfastness.

As desirable colorant, known pigments such as carbon black, aniline black, aniline blue, calcoil blue, chrome yellow, ultramarine blue, Dupont oil red, quinoline yellow, methylene blue chloride, phthalocyanine blue, malachite green oxalate, lamp black, rose bengal, quinacridone, benzidine yellow, C. I. Pigment Red 48:1, C. I. Pigment Red 57:1, C. I. Pigment Red 122, C. I. Pigment Red 185, C. I. Pigment Red 238, C. I. Pigment Yellow 12, C. I. Pigment Yellow 17, C. I. Pigment Yellow 180, C. I. Pigment Yellow 97, C. I. Pigment Yellow 74, C. I. Pigment Blue 15:1, C. I. Pigment Blue 15:3 may be used.

The content of the colorant is preferably in a range of 1 part by mass to 30 parts by mass with respect to 100 parts by mass of the binder resin. In addition, it is also effective that if necessary, a surface-treated colorant may be used or a pigment dispersant may be used.

By selecting the kind of the colorant, a yellow toner, a magenta toner, a cyan toner, and a black toner can be obtained.

### (Release Agent)

Examples of the release agent include paraffin wax such as low molecular weight polypropylene and low molecular weight polyethylene; a silicone resin; rosins; a rice wax; and a carnauba wax. The melting temperature of the release agent is preferably 50° C. to 100° C., and more preferably 60° C. to 95° C. The content of the release agent in a toner is preferably 0.5% by mass to 15% by mass, and more preferably 1.0% by mass to 12% by mass. When the content of the release agent is 0.5% by mass or greater, in particular, in an oilless fixing, occurrence of a peeling failure is prevented. When the content of the release agent is 15% by mass or less, the fluidity of the toner is not deteriorated, and the image quality and the reliability of image formation are improved.

### (Charge Control Agent)

As the charge control agent, known charge control agents may be used, and resin type charge control agents containing an azo-based metal complex compound, a metal complex compound of salicylic acid, or a polar group may be used.

### (External Additive)

The toner according to the embodiment may contain inorganic powder as an external additive of the toner particles to improve fluidity or the like.

Examples of the suitable inorganic particle include silica, alumina, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, trioxide antimony, magnesium oxide, zirconium oxide, barium sulfate, barium carbonate, calcium carbonate, silicon carbide, and silicon nitride. However, silica is particularly preferable. The ratio of the inorganic powder to be mixed in the toner is usually in a range of 0.01 parts by mass to 5 parts by mass, and preferably in a range of 0.01 parts by mass to 2.0 parts by mass with respect to 100 parts by mass of the toner. In addition, the inorganic powder may be used in combination with known materials such as silica, titanium, resin particles (resin particles such as polystyrene, PMMA, and melamine resin), and alumina. In addition, as a cleaning activating agent, metal salts of higher fatty acid represented by zinc stearate, or particle powder of fluorine-based polymer may be added.

### [Properties of Toner]

A form coefficient SF1 of the toner according to the embodiment is preferable in a range of 110 to 150, and more preferably in a range of 120 to 140.

Here, the form coefficient SF1 is determined by the following formula (1).

SF1=(ML²/A)×(π/4)×100 Formula (1)

In the above formula (1), ML is an absolute maximum length of a toner and A is a projected area of the toner, respectively.

SF1 is digitized by analyzing mainly a microscope image or a scanning electron microscope (SEM) image using an image analyzer, and for example, is calculated in the following manner. That is, SF1 is obtained in the following manner. First, an optical microscope image of the particles dispersed on a surface of a slide glass is taken into a Luzex image analyzer through a video camera, maximum lengths and projected areas of 100 particles are determined, and calculation is performed by the above formula (1) to obtain the average value.

The volume average particle diameter of the toner according to the embodiment is preferable in a range of 4 μm to 15 μm, more preferable in a range of 4 μm to 10 μm, and even more preferable in a range of 4 μm to 8 μm.

Moreover, the measurement of the volume average particle diameter is performed at an aperture diameter of 50 μm using Coulter Multisizer (manufactured by Beckman Coulter Inc.). In this time, after the toner is dispersed in electrolytic aqueous solution (isotonic aqueous solution) and is dispersed by irradiating with ultrasonic waves for 30 seconds or more, the measurement was performed.

### [Method for Producing Toner]

The method for producing the toner according to the embodiment is not particularly limited, and toner particles are prepared by the dry method such as a kneading and pulverizing method, or the wet method such as an emulsion aggregation method and a suspension polymerization method, and if necessary, an external additive is externally added to the toner particles, whereby the toner is obtained.

The kneading and pulverizing method is a method for producing toner particles in which the toner forming material including a binder resin is kneaded to obtain a kneaded material, and the obtained kneaded material is pulverized to obtain the toner particles.

In more detail, the kneading and pulverizing method is divided into a kneading step of kneading the toner forming material including a binder resin and a pulverizing step of pulverizing the kneaded material.

If necessary, a cooling step of cooling the kneaded material formed in the kneading step, and other steps may be included in the kneading and pulverizing method.

Each step will be described in detail.

### —Kneading Step—

In the kneading step, the toner forming material including a binder resin is kneaded.

In the kneading step, an aqueous medium (for example, water such as distilled water and ion exchange water, alcohol, or the like) of 0.5 parts by mass to 5 parts by mass with respect to 100 parts by mass of the toner forming material is preferably added.

As a kneader used in the kneading step, for example, a single screw extruder and a twin screw extruder can be exemplified. Hereinafter, as one example of the kneader, a kneader having a transport screw portion and two kneading portions will be described with reference to the drawings, but the embodiment is not limited thereto.

FIG. 1 is a diagram illustrating a state of a screw as an example of a screw extruder used in the kneading step in producing the toner according to the embodiment.

A screw extruder 11 is constituted with a barrel 12 equipped with a screw (not shown), an injection port 14 for injecting a toner forming material which is a raw material of the toner in the barrel 12, a liquid addition port 16 for adding an aqueous medium to the toner forming material in the barrel 12, and a discharging port 18 for discharging the kneaded material formed by kneading the toner forming material in the barrel 12.

The barrel 12 is divided into a transport screw portion SA for transporting the toner forming material injected from the injection port 14 to a kneading portion NA, the kneading portion NA for melting and kneading the toner forming material by a first kneading step, a transport screw portion SB for transporting the toner forming material melted and kneaded in the kneading portion NA to a kneading portion NB, the kneading portion NB for forming the kneaded material by melting and kneading the toner forming material by a second kneading step, and a transport screw portion SC for transport the formed kneaded material to the discharging port 18, in order from the closest side to the injection port 14.

In addition, in the inner portion of the barrel 12, temperature control means (not shown) which is different for each block is equipped. That is, the temperature control means is constituted to be controlled to each different temperature from block 12A to block 12J. Moreover, FIG. 1 shows a state in which the temperature of the blocks 12A and 12B is controlled to t 0° C., the temperature of the blocks from 12C to 12E is controlled to t 1° C., and the temperature of the blocks from 12F to 12J is controlled to t 2° C., respectively. Thus, the toner forming material of the kneading portion NA is heated to t 1° C., and the toner forming material of the kneading portion NB is heated to t 2° C.

When the toner forming material including a binder resin is supplied from the injection port 14 to the barrel 12, the toner forming material is transported to the kneading portion NA by the transport screw portion SA. At this time, since the temperature of the block 12C is set to t 1° C., the toner forming material is transported into the kneading portion NA in a state changed to a molten state by being heated. Since the temperature of the blocks 12D and 12E is also set to t 1° C., in the kneading portion NA, the toner forming material is melted and kneaded at a temperature oft 1° C. The binder resin becomes a molten state in the kneading portion NA, and sheared by the screw.

Next, the toner forming material kneaded in the kneading portion NA is transported to the kneading portion NB by the transport screw portion SB.

Then, in the transport screw portion SB, by injecting an aqueous medium from the liquid addition port 16 to the barrel 12, the aqueous medium is added to the toner forming material. In addition, FIG. 1 shows a form of injecting the aqueous medium at the transport screw portion SB, however, the embodiment is not limited thereto. The aqueous medium may be injected at the kneading portion NB, and the aqueous medium may be injected at both the transport screw portion SB and the kneading portion NB. That is, the position or the injecting place at which the aqueous medium is injected is suitably selected as necessary.

As described above, by injecting the aqueous medium from the liquid addition port 16 to the barrel 12, the toner forming material and the aqueous medium are mixed in the barrel 12, the toner forming material is cooled by the latent heat of vaporization of the aqueous medium, and thus the temperature of the toner forming material can be suitably maintained.

Finally, the kneaded material formed by the melting and kneading by the kneading portion NB is transported to the discharging port 18 by the transport screw portion SC, and discharged from the discharging port 18.

As described above, the kneading step using the screw extruder 11 shown in FIG. 1 is performed.

### —Cooling Step—

The cooling step is a step of cooling the kneaded material formed in the kneading step, and in the cooling step, cooling is preferably performed from the temperature of the kneaded material at the time when the kneading step ended to equal to or less than 40° C. at an average temperature decrease rate of 4° C./sec. When rapidly cooling at the above average temperature decrease rate, the dispersion state immediately after the kneading step ended is maintained as it is, and thus, it is preferable. Moreover, the average temperature decrease rate refers to an average value of the rate to be lowered from the temperature (for example, in a case of using a screw extruder 11 in FIG. 1, t 2° C.) of the kneaded material at the time when the kneading step ended to 40° C.

Specific examples of the cooling method in the cooling step include a method using a rolling roll in which cold water or brine is circulated or an insertion type cooling belt. Moreover, in a case of performing cooling by the above method, the cooling rate is determined by the speed of the rolling roll, the flow rate of brine, the supply amount of the kneaded material, and the slab thickness at the time of rolling the kneaded material. The slab thickness is preferably 1 mm to 3 mm.

### —Pulverizing Step—

The kneaded material cooled by the cooling step is pulverized by the pulverizing step, and particles are formed. In the pulverizing step, for example, a mechanical pulverizer, a jet type pulverizer, or the like is used.

### —Classifying Step—

In order to obtain toner particles having the volume average particle diameter in a range of interest, if necessary, the particles obtained by the pulverizing step may be classified by a classifying step. In the classifying step, a centrifugal type classifier or an inertia type used in the related art is used to remove fine particles (particles smaller than the particle diameter in a range of interest) and coarse particles (particles larger than the particle diameter in a range of interest).

### —Externally Adding Step—

The above-described inorganic powder may be externally added to the obtained toner particles for the purpose of charge control, fluidity imparting, charge exchangeability imparting, or the like. For example, these are performed by a V type blender, a Henschel mixer, a lodige mixer, or the like, and these are attached on a separate stage.

### —Sieving Step—

After the above externally adding step, a sieving step may be performed, if necessary. As a sieving method, specifically, for example, methods using a gyro sifter, a vibration sifter, and a wind sifter can be exemplified. By sieving, coarse particles of the external additive are removed, and occurrence of streaks on the photoreceptor and contamination by dirt in the apparatus are suppressed.

In the toner according to the embodiment, it is preferable that the specific polyester resin exist without being unevenly distributed in of the toner. To make the toner take such a form, the toner is preferably produced by a wet method such as the emulsion aggregation method and the suspension polymerization method.

The emulsion aggregation method may have a emulsifying step of forming resin particles (emulsified particles) by emulsifying raw materials constituting the toner, an aggregation step of forming aggregate including the resin particles, and a fusing step of fusing the aggregate.

The steps will be specifically described below.

### —Emulsifying Step—

For example, the preparation of a resin particle dispersion may be performed by applying a shearing force by a disperser to a solution obtained by mixing an aqueous medium and a binder resin. At that time, particles may be formed by reducing the viscosity of the resin component by heating. In addition, a dispersant may be used to stabilize the dispersed resin particles.

Furthermore, if the resin is oily and is dissolved in a solvent having a relatively low solubility in water, the resin is particle-dispersed in water with a dispersant or a polymer electrolyte by dissolving in the solvent of the resin, and by evaporating the solvent by heating or reducing pressure, resin particle dispersion is produced.

Here, when preparing the resin particle dispersion, in a case where using the specific polyester resin used as a binder resin and a known binder resin in combination, one resin particle dispersion may be prepared in a state of being mixed at a ratio described above, or two resin particle dispersion including different resins are prepared, and then, these may be mixed in the following aggregation step. Moreover, the mixing conditions such as a mixing order are not particularly limited.

Examples of the aqueous medium include water such as distilled water and ion exchange water, and alcohols, and among these, water is preferable.

In addition, examples of the dispersant used in the emulsifying step include water-soluble polymers such as polyvinyl alcohol, methyl cellulose, ethyl cellulose, hydroxyethyl cellulose, carboxymethyl cellulose, sodium polyacrylate, and poly(sodium methacrylate); surfactants including anionic surfactants such as sodium dodecylbenzene sulfonate, sodium octadecyl sulfate, sodium oleate, sodium laurate, and potassium stearate, cationic surfactants such as lauryl amine acetate, stearyl amine acetate, and lauryl trimethyl ammonium chloride, ampholytic surfactants such as lauryl dimethyl amine oxide, and nonionic surfactants such as polyoxyethylene alkyl ether, polyoxyethylene alkyl phenyl ether, and polyoxyethylene alkyl amine; and inorganic salts such as tricalcium phosphate, aluminum hydroxide, calcium sulfate, calcium carbonate, and barium carbonate.

Examples of the disperser used for the production of the emulsion include a homogenizer, a homomixer, a pressure kneader, an extruder, and a media disperser. As the resin particle size, the average particle diameter (volume average particle diameter) is preferably 1.0 μm or less, more preferably in a range of 60 nm to 300 nm, and even more preferably in a range of 150 nm to 250 nm. When the particle size is less than 60 nm, the resin particles are stable in a dispersion, and thus, there is a case where aggregation of the resin particles is difficult. In addition, when the particle size is greater than 1.0 μm, aggregability of the resin particles is improved, and thus it is easy to produce the toner particles, however, there is a case where distribution of the toner particle diameters is widen.

In the preparation of the release agent dispersion, after a release agent is dispersed with a polymer electrolyte such as an ionic surfactant, a polymer acid, and a polymer base in water, heating is performed to a temperature higher than the melting temperature of the release agent, and a dispersion treatment is performed using a homogenizer or a pressure discharging type disperser by which strong shearing force is imparted. Through the above treatment, the releasing agent dispersion can be obtained. When performing the dispersion treatment, inorganic compounds such as poly aluminum chloride may be added to the dispersion. Examples of the preferable inorganic compound include poly aluminum chloride, aluminum sulfate, highly basic poly aluminum chloride (BAC), poly aluminum hydroxide, and aluminum chloride. Among these, poly aluminum chloride and aluminum sulfate are preferable. The above release agent dispersion is used in the emulsion aggregation method, and the above release agent dispersion may also be used when producing a toner by the suspension polymerization method.

By the dispersion treatment, a release agent dispersion including release agent particles having a volume average particle diameter of 1 μm or less is obtained. Moreover, a more preferable volume average particle diameter of the release agent particles is 100 nm to 500 nm.

When the volume average particle diameter is less than 100 nm, in general, the release agent component is less likely to be incorporated in the toner, though this is also affected by the characteristics of the binder resin used. In addition, when the volume average particle diameter is greater than 500 nm, there is a case where the dispersion state of the release agent in the toner becomes insufficient.

In the preparation of the colorant dispersion, it is possible to use known dispersion methods, and for example, it is possible to adopt generally used dispersing means such as a rotary shearing type homogenizer, a ball mill having media, a sand mill, a dynoill, an ultimizer, however, there is no limitation thereto. The colorant is dispersed with a polymer electrolyte such as an ionic surfactant, polymer acid, and polymer base in water. The volume average particle diameter of the colorant particles dispersed may be 1 μm or less, and when the volume average particle diameter is in a range of 80 nm to 500 nm, aggregability is not impaired and dispersion of the colorant in the toner is excellent.

### —Aggregation Step—

In the aggregation step, a dispersion of resin particles, the colorant dispersion, the release agent dispersion, and the like are mixed to make a mixed solution, and the mixed solution is heated at a temperature below the glass transition temperature of the resin particles to aggregate, whereby aggregated particles are formed. In many cases, the aggregated particles are formed by acidifying the pH of the solution while being stirred. As the pH, a range of 2 to 7 is preferable, and at this time, the use of a coagulant is also effective.

Moreover, in the aggregation step, the release agent dispersion may be added and mixed at once together with various dispersions such as a resin particle dispersion and the like, and may be added by dividing into several times.

As the coagulant, a surfactant having opposite polarity to that of the surfactant used in the above-described dispersant, inorganic metal salts, and a divalent or higher metal complex can be suitably used. In particular, in a case of using the metal complex, it is possible to reduce the amount of surfactant used and improve the charging characteristics, it is particularly preferable.

As the inorganic metal salts, in particular, aluminum salts and polymers thereof are preferable. In order to obtain a narrower particle size distribution, as the valence of the inorganic metal salt, a divalent inorganic metal salt is better than a monovalent inorganic metal salt, a trivalent inorganic metal salt is better than a divalent inorganic metal salt, and a tetravalent inorganic metal salt is better than a trivalent inorganic metal salt, and even if the valence is the same, a polymer type inorganic metal salt polymer is more suitable.

In addition, by additionally adding (coating step) the resin particle dispersion when the aggregated particles becomes desired particle diameter, a toner having a constitution in which the surfaces of the core particles are coated with a resin may be prepared. In this case, the release agent and the colorant are less likely to be exposed on the toner surface, and thus, the constitution is preferable from the viewpoint of electrostatic property and developability. In a case of additionally adding, before the additional addition, a coagulant may be added, or pH adjustment may be performed.

### —Fusing Step—

In the fusion step, by increasing the pH of the suspension of the agglomerated particles to a range of 3 or higher and 9 or less under the stirring conditions conforming to the aggregation step, the progress of the aggregation is stopped, and by heating to a temperature above the glass transition temperature of the resin, the aggregated particles are fused. In addition, in a case where the aggregated particles are coated with the resin, the resin is also fused, and the core agglomerated particles are coated. The heating may be performed until fusion occurs, and the heating time may be about 0.5 hours or longer and 10 hours or less.

By cooling after fusion, fused particles are obtained. In addition, in the cooling step, crystallization may be promoted by dropping the cooling rate near the glass transition temperature of the resin (range of the glass transition temperature±10° C.), that is, performing a so-called slow cooling.

The fused particles obtained by fusion are made to be toner particles through a solid-liquid separation step such as filtration, or a cleaning step or a drying step if necessary. In a case where the external additive is not externally added to the toner particles, the obtained toner particles may be used as a toner.

### —Externally Adding Step—

The above-described inorganic powder may be externally added to the obtained toner particles in the same manner as the case of the kneading and pulverizing method. The method for externally adding the inorganic powder is the same as in the case of the kneading and pulverizing method.

### <Electrostatic Charge Image Developer>

An electrostatic charge image developer (hereinafter, referred to as “developer”) according to the embodiment includes at least the toner according to the embodiment.

The toner according to the embodiment as it is used as one-component developer, or two-component developer. In a case of being used as the two-component developer, the toner is used as a mixture with a carrier.

As the carrier which can be used in the two-component developer, which is not particularly limited, known carriers may be used. Examples thereof include magnetic metals such as iron oxide, nickel, and cobalt, magnetic oxides such as ferrite and magnetite, resin-coated carriers having resin coating layers on the surfaces of these core materials, and magnetic dispersion type carriers. In addition, the carrier may be a resin dispersion type carrier in which a conductive material or the like is dispersed in a matrix resin.

In the above two-component developer, the mixing ratio (mass ratio) of the toner and the carrier is preferably a range of about 1:100 (toner:carrier) to 30:100 (toner:carrier), and more preferably a range of about 3:100 (toner:carrier) to 20:100 (toner:carrier).

### <Image Forming Apparatus and Image Forming Method>

Next, the image forming apparatus according to the embodiment using the developer according to the embodiment will be described.

The image forming apparatus according to the embodiment is equipped with a latent image carrier, charging means for charging on the surface of the latent image carrier, electrostatic latent image forming means for forming the electrostatic latent image on the surface of the latent image carrier, developing means for containing the developer according to the embodiment and forming a toner image by developing the electrostatic latent image with the developer, transferring means for transferring the toner image to recording medium, and fixing means for fixing the toner image to the recording medium.

By the image forming apparatus according to the embodiment, the image forming method according to the embodiment which has a charging step for charging on the surface of the latent image carrier, an electrostatic latent image forming step for forming the electrostatic latent image on the surface of the latent image carrier, a developing step for forming a toner image by developing the electrostatic latent image with the developer according to the embodiment, a transferring step for transferring the toner image to recording medium, and a fixing step for fixing the toner image to the recording medium is carried out.

Moreover, in the image forming apparatus, for example, a part including the developing means may be a cartridge structure (process cartridge) which is attached to and detached from the image forming apparatus main body. As the process cartridge, the process cartridge according to the embodiment which is equipped with the developing means for containing the developer according to the embodiment and forming a toner image by developing the electrostatic latent image formed on the surface of the latent image carrier with the developer and is attached to and detached from the image forming apparatus is suitably used.

Hereinafter, one examples of the image forming apparatus according to the embodiment will be described, but the embodiment is not limited thereto. Moreover, major portions shown in the drawing will be described, and description of other portions will be omitted.

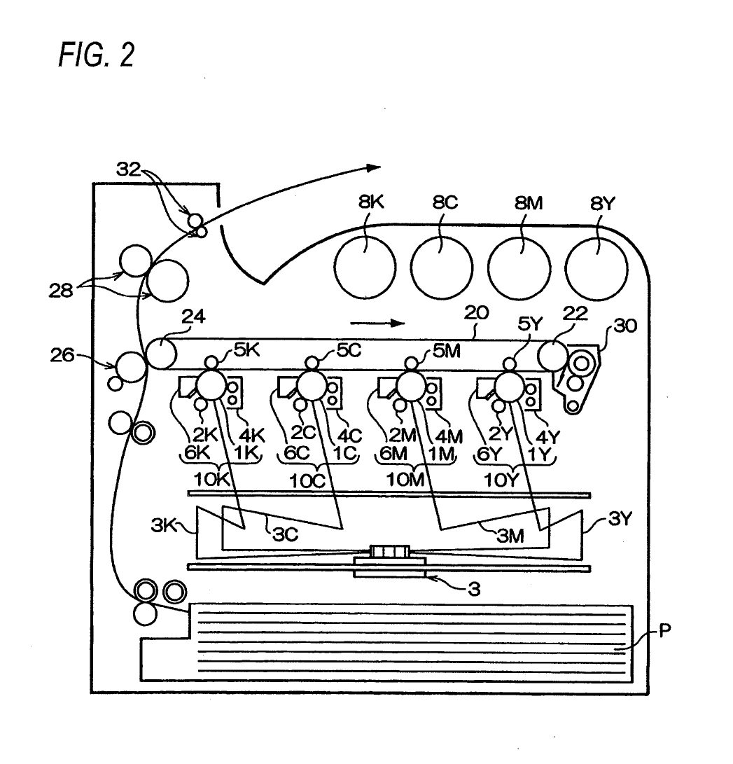

FIG. 2 is a schematic configuration view showing a color image forming apparatus of a four tandem method. e image forming apparatus shown in FIG. 2 is equipped with first to fourth image forming units 10Y, 10M, 10C, and 10K (image forming means) of an electrophotographic system that outputs an image of each color of yellow (Y), magenta (M), cyan (C), and black (K) based on color-separated image data. These image forming units (hereinafter, also simply referred to as “unit”) 10Y, 10M, 10C, and 10K are arranged apart a predetermined distance from each other in the horizontal direction. Moreover, these units 10Y, 10M, 10C, and 10K may be process cartridges which are attached to and detached from the image forming apparatus main body.

An intermediate transfer belt 20 as an intermediate transfer member is extended through each unit on the upper side in drawings of each unit of 10Y, 10M, 10C, and 10K. The intermediate transfer belt 20 is provided so as to wind a drive roller 22 and a support roller 24 which are in contact with the inner surface of the intermediate transfer belt 20, and so as to run in the direction toward the fourth unit 10K from the first unit 10Y. Moreover, the support roller 24 is biased in a direction separating from the drive roller 22 by springs not shown in the drawing, and predetermined tension is provided to the intermediate transfer belt 20 winding the drive roller 22 and the support roller 24. In addition, an intermediate transfer member cleaning device 30 is provided so as to face the drive roller 22 on the latent image carrier side surface of the intermediate transfer belt 20.

In addition, a toner of four colors of yellow, magenta, cyan, and black contained in toner cartridges of 8Y, 8M, 8C, and 8K can be supplied to each of developing devices (developing means) 4Y, 4M, 4C, and 4K of each unit of 10Y, 10M, 10C, and 10K.

Since the first to the fourth units 10Y, 10M, 10C, and 10K described above have the same constitution, here, the first unit 10Y for forming a yellow image which is arranged the upstream side in the intermediate transfer belt running direction will be described as a representative example. Moreover, by putting the same reference signs including magenta (M), cyan (C), and black (K) instead of yellow (Y) on the same part as the first unit 10Y, description of the second to the fourth units 10M, 10C, and 10K is omitted.

And the first unit 10Y has a photoreceptor 1Y that functions as a latent image carrier. Around the photoreceptor 1Y, a charging roller 2Y for charging the surface of the photoreceptor 1Y to a predetermined potential, an exposure device 3 for forming an electrostatic latent image by exposing the charged surface to a laser beam 3Y based on the color-separated image signal, a developing device (developing means) 4Y for developing an electrostatic latent image by supplying a charged toner to the electrostatic latent image, a primary transfer roller (primary transferring means) 5Y for transferring the developed toner image onto the intermediate transfer belt 20, and photoreceptor cleaning device (cleaning means) 6Y for removing toner remaining on the surface of the photoreceptor 1Y after the primary transfer are arranged in this order.

In addition, the primary transfer roller 5Y is disposed on the inner side of the intermediate transfer belt 20, and is provided at the position facing the photoreceptor 1Y. Furthermore, to each of the primary transfer rollers 5Y, 5M, 5C, and 5K, bias power source (not shown) for applying a primary transfer bias is connected respectively. Each bias power source changes the transfer bias applied to each primary transfer roller by control by a control portion not shown in the drawing.

Hereinafter, the operation of forming a yellow image in the first unit 10Y will be described. First, prior to the operation, the surface of the photoreceptor 1Y is charged to a potential of about −600V or greater to −800V or less by the charging roller 2Y.

The photoreceptor 1Y is formed by laminating a photosensitive layer onto an electrically conductive (volume resistivity at 20° C.: 1×10⁻⁶ Ωcm or less) substrate. The photosensitive layer usually has high resistance (about resistance of general resin), however, when the laser beam 3Y is irradiated, the photosensitive layer has a property that the specific resistance of the portion to which the laser beam is irradiated is changed. Therefore, the laser beam 3Y is output on the surface of the charged photoreceptor 1Y according to the image data for yellow transmitted from the control portion not shown in the drawing through the exposure device 3. The laser beam 3Y is irradiated to the photosensitive layer on the surface of the photoreceptor 1Y, and by this, an electrostatic latent image having a yellow print pattern is formed on the surface of the photoreceptor 1Y.

The electrostatic latent image is an image formed on the surface of the photoreceptor 1Y by charging, and a so-called negative latent image formed in the manner in which specific resistance of the irradiated part of the photosensitive layer is decreased by the laser beam 3Y, charges charged on the surface of the photoreceptor 1Y flows, and on the other hand, the charge of the part which is not irradiated with the laser beam 3Y remains.

The electrostatic latent image formed on the photoreceptor 1Y in this manner is rotated to a predetermined developing position according to the running of the photoreceptor 1Y. And, in this developing position, the electrostatic latent image on the photoreceptor 1Y becomes a visible image (developed image) by the developing device 4Y.

A yellow developer contained in the developing device 4Y is frictionally charged by being stirred in the inner portion of the developing device 4Y, and is held on a developer roller (developer carrier) with a charge of the same polarity (negative polarity) as the charge charged on the photoreceptor 1Y. Then, the surface of the photoreceptor 1Y passes through the developing device 4Y, a yellow toner attaches electrostatically to a latent image portion discharged on the surface of the photoreceptor 1Y, and a latent image is developed by the yellow toner. The photoreceptor 1Y on which a yellow toner image is formed is run continuously at a predetermined speed, and the toner image developed on the photoreceptor 1Y is transported to a predetermined primary transfer position.

After the yellow toner image on the photoreceptor 1Y is transported to the primary transfer position, a predetermined primary transfer bias is applied to the primary transfer roller 5Y, electrostatic force toward the primary transfer roller 5Y from the photoreceptor 1Y acts on the toner image, and the toner image on the photoreceptor 1Y is transferred onto the intermediate transfer belt 20. The transfer bias applied at this time has polarity (+) opposite to the polarity (−) of the toner, and for example, in the first unit 10Y, the transfer bias is controlled to about +10 μA by the control portion (not shown).

On the other hand, the toner remaining on the photoreceptor 1Y is removed in the photoreceptor cleaning device 6Y and collected.

In addition, the primary transfer bias applied to the primary transfer rollers 5M, 5C, and 5K after a second unit 10M is also controlled in the same manner as in the first unit.

In this way, the intermediate transfer belt 20 on which the yellow toner image is transferred in the first unit 10Y is sequentially transported through the second to the fourth units 10M, 10C, and 10K, and a superimposed toner image is formed by superimposition of toner images having respective colors.

The intermediate transfer belt 20 on which a toner images of four colors are superimposed through the first to the fourth units reaches a secondary transfer portion constituted with the intermediate transfer belt 20, the support roller 24 which are in contact with the inner surface of the intermediate transfer belt 20, and a secondary transfer roller (secondary transferring means) 26 which is disposed on the image holding surface side of the intermediate transfer belt 20. On the other hand, a recording sheet (recording medium) P is supplied to a gap at which the secondary transfer roller 26 is pressed against the intermediate transfer belt 20 through a supply mechanism at a predetermined time, and a predetermined secondary transfer bias is applied to the support roller 24. The transfer bias applied at this time has the same polarity (−) as the polarity (−) of the toner, electrostatic force toward the recording sheet P from the intermediate transfer belt 20 acts on the superimposed toner image, and the superimposed toner image on the intermediate transfer belt 20 is transferred onto the recording sheet P. The secondary transfer bias at this time is a transfer bias determined according to the resistance detected by resistance detection means (not shown) for detecting the resistance of the secondary transfer portion, and is voltage-controlled.

After this, the recording sheet P is transported into a fixing device (fixing means) 28, the superimposed toner image is heated, and the color-superposed toner image is melted and fixed on the recording sheet P. The recording sheet P on which the fixation of the color image is completed is transported toward the discharging portion by a transport roll (discharging roll) 32, whereby a series of color image forming operations is completed.

Moreover, the image forming apparatus exemplified above has a constitution in which a superimposed toner image is transferred onto the recording sheet P through the intermediate transfer belt 20, however the embodiment is not limited to this constitution, and the image forming apparatus may have a structure in which a toner image is directly transferred onto the recording sheet from the photoreceptor.

### <Process Cartridge and Toner Cartridge>

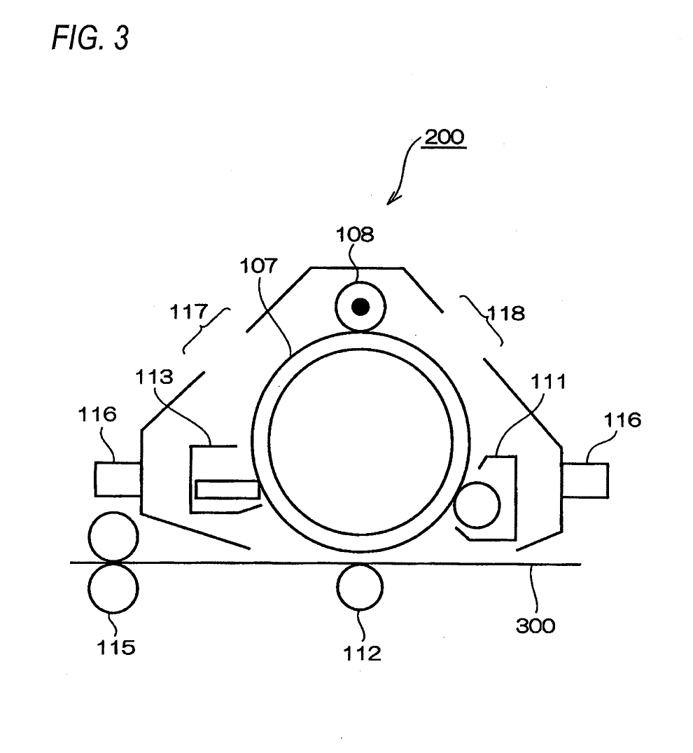

FIG. 3 is a schematic configuration view showing a suitable example of a process cartridge containing the developer according to the embodiment. The process cartridge 200 is integrated by combining a charging device 108, a developing device 111, a photoreceptor cleaning device (cleaning means) 113, an opening portion 118 for exposure, and an opening portion 117 for destaticization exposure, together with a photoreceptor 107 using a mounting rail 116.

The above process cartridge 200 is attachable to and detachable from the image forming apparatus main body constituted with a transfer device 112, a fixing device 115, and other components not shown in the drawing, and constitutes the image forming apparatus together with the image forming apparatus main body. Moreover, 300 is a recording sheet.

In the process cartridge 200 shown in FIG. 3, the photoreceptor 107, the charging device 108, the developing device 111, the photoreceptor cleaning device 113, the opening portion 118 for exposure, and the opening portion 117 for destaticization exposure are equipped, and these devices may be selectively combined. In the process cartridge according to the embodiment, at least one selected from a group constituted with the photoreceptor 107, the charging device 108, the photoreceptor cleaning device (cleaning means) 113, the opening portion 118 for exposure, and the opening portion 117 for destaticization exposure may be equipped in addition to the developing device 111.

Next, a toner cartridge will be described.

The toner cartridge is detachably and attachably mounted on the image forming apparatus, and at least, in the toner cartridge containing a toner to be supplied to the developing means arranged in the image forming apparatus, the above toner is a toner according to the embodiment described above. Moreover, in the toner cartridge, at least a toner may be contained, and depending on the mechanism of the image forming apparatus, for example, a developer may be contained.

Moreover, the image forming apparatus shown in FIG. 2 is an image forming apparatus having a constitution in which the toner cartridges 8Y, 8M, 8C, and 8K are detachable and attachable, and the developing devices 4Y, 4M, 4C, and 4K are connected to the toner cartridges corresponding to respective developing devices (color) with a developer supply pipe not shown in the drawing. In addition, in a case where the amount of the developer contained in the toner cartridge becomes small, this toner cartridge is replaced.

### EXAMPLES

Hereinafter, the embodiment will be specifically described by Examples, and the embodiment is not limited to the following Examples. Moreover, “part” and “%” in the following Examples respectively represent “parts by mass” and “% by mass” unless otherwise noted.

### [Measurement Method of Various Physical Properties]

### <Measurement of Acid Value>

Acid values are measured by a neutralization titration method according to JIS K0070. That is, an appropriate amount of a sample is taken, 100 ml of a solvent (diethyl ether/ethanol mixture solution) and few drops of an indicator (phenolphthalein solution) are added thereto, and the mixture is sufficiently shaken until the sample is completely dissolved in a water bath. To this, 0.1 mol/l potassium hydroxide ethanol solution is titrated, and the time when the faint red color of the indicator has continued for 30 seconds is taken as the end point of the titration. When the acid value is A, the amount of sample is S (g), the amount of the 0.1 mol/l potassium hydroxide ethanol solution used in the titration is B (ml), and f is a factor of the 0.1 mol/l potassium hydroxide ethanol solution, the acid value is calculated by A=(B×f×5.611)/S.

### <Measurement of Weight Average Molecular Weight Mw and Number Average Molecular Weight Mn>

Two “HLC-8120 GPC and SC-8020 (manufactured by Tosoh Corporation, 6.0 mm ID×15 cm)” are used, and THF (tetrahydrofuran) is used as an eluent. The experiment is performed using an RI detector under the experimental conditions of a sample concentration of 0.5%, a flow rate of 0.6 ml/min, a sample injection amount of 10 μl, and a measurement temperature of 40° C. In addition, a calibration curve is created from 10 samples of “polystyrene standard sample TSK standard”: “A-500”, F-1″, “F-10”, “F-80”, “F-380”, “A-2500”, “F-4”, “F-40”, “F-128”, and “F-700” manufactured by Tosoh Corporation.

### <Measurement of Glass Transition Temperature>

Using “DSC-20” (manufactured by SEIKO Electronics Industrial Co., Ltd.), 10 mg of the sample is heated at a constant temperature increase rate (10° C./min) and measurement is performed.

### <Measurement of Softening Temperature>

The softening temperature is determined as the temperature corresponding to half of the height of an end point from an outflow starting point when a sample of 1 cm³ is melted and flown out under the conditions of a diameter of a dice of 0.5 mm, a pressurized load of 0.98 MPa (10 kg/cm²), and a temperature increase rate of 1° C./min using a higher performance type flow tester CFT-500 (manufactured by Shimadzu Corporation).

### Synthesis Example 1

### Synthesis of rosin diol 1 (exemplified compound (10))

100 parts by mass of neopentyl glycol diglycidyl (reagent, manufactured by Tokyo Chemical Industry Co., Ltd.) as a bifunctional epoxy compound, 200 parts by mass of disproportionated rosin (trade name: Pine Crystal KR614, manufactured by Arakawa Chemical Industries, Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 1 is obtained.

### Synthesis Example 2

### Synthesis of rosin diol 2 (exemplified compound (16))

100 parts by mass of neopentyl glycol diglycidyl (reagent, manufactured by Tokyo Chemical Industry Co., Ltd.) as a bifunctional epoxy compound, 205 parts by mass of hydrogenated rosin (trade name: HYPALE CH, manufactured by Arakawa Chemical Industries, Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 2 is obtained.

### Synthesis Example 3

### Synthesis of rosin diol 3 (exemplified compound (4))

100 parts by mass of neopentyl glycol diglycidyl (reagent, manufactured by Tokyo Chemical Industry Co., Ltd.) as a bifunctional epoxy compound, 200 parts by mass of purified rosin (trade name: Pine Crystal KR65, manufactured by Arakawa Chemical Industries, Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 3 is obtained.

### Synthesis Example 4

### Synthesis of rosin diol 4 (exemplified compound (15))

80 parts by mass of ethylene glycol diglycidyl (reagent, manufactured by Tokyo Chemical Industry Co., Ltd.) as a bifunctional epoxy compound, 200 parts by mass of hydrogenated rosin (trade name: HYPALE CH, manufactured by Arakawa Chemical Industries, Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 4 is obtained.

### Synthesis Example 5

### Synthesis of rosin diol 5 (exemplified compound (2))

90 parts by mass of propylene glycol diglycidyl (reagent, manufactured by Wako Pure Chemical Industries, Ltd.) as a bifunctional epoxy compound, 200 parts by mass of purified rosin (trade name: Pine Crystal KR65, manufactured by Arakawa Chemical Industries, Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 5 is obtained.

### Synthesis Example 6

### Synthesis of rosin diol 6 (comparative rosin diol)

115 parts by mass of bisphenol A diglycidyl (reagent, manufactured by Tokyo Chemical Industry Co., Ltd.) as a bifunctional epoxy compound, 200 parts by mass of disproportionated rosin (trade name: Pine Crystal KR614, manufactured by Arakawa Chemical Industries, Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg. KOH/g, the reaction is stopped, whereby a rosin diol 6 is obtained.

### Synthesis Example 7

### Synthesis of rosin diol 7 (comparative rosin diol)

105 parts by mass of Terephthalic acid diglycidyl (trade name: Denacol EX711, manufactured by Nagase ChemteX Corporation) as a bifunctional epoxy compound, 200 parts by mass of hydrogenated rosin (trade name: HYPALE CH, manufactured by Arakawa Chemical Industries, Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 7 is obtained.

### Synthesis Example A

### Synthesis of specific polyester resin 1

85 g of terephthalic acid (TPA) as a Polycarboxylic acid component, 60 g of the rosin diol 1 and 40 g of neopentyl glycol as a polyol component, and 0.1 g of tetra-n-butyl titanate as a reaction catalyst are put into a reaction vessel made of stainless equipped with a stirrer, a heater, a thermometer, a fractional distillation device, and a nitrogen gas inlet tube, a polycondensation reaction is performed at 230° C. for 9 hours in a nitrogen atmosphere while stirring, and it is confirmed that the molecular weight and the acid value reaches predetermined values, whereby a specific polyester resin 1 is synthesized.

The weight average molecular weight Mw and the number average molecular weight Mn, the acid value, and the glass transition temperature of the obtained rosin resin 1 are measured by the method described above. The measurement results are shown in Table 1.

### Synthesis Examples B to P

In the same method as in the synthesis of the specific polyester resin 1 in Synthesis Example A, using monomer components described in the following Table 1 at the content ratios (molar ratios) described in the following Table 1, specific polyester resins 2 to 11 and comparative polyester resins C1 to C5 are synthesized.

The weight average molecular weight Mw and the number average molecular weight Mn, the acid value, and the glass transition temperature of the obtained polyester resins are measured by the method described above. The measurement results are also shown in Table 1.

TABLE 1

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Toner, | 1 | 2 | 3 | 4 | 5 | 6 | 7 | 8 | 9 | 10 | 11 |
| developer, resin | | | | | | | | | | | |
| particle dispersion No. | | | | | | | | | | | |
| Specific or comparative | 1 | 2 | 3 | 4 | 5 | 6 | 7 | 8 | 9 | 10 | 11 |
| polyester No. | | | | | | | | | | | |
| (B) Rosin diol | | | | | | | | | | | |
| 1 | 10 | — | — | — | — | — | — | — | 2 | 10 | 10 |
| 2 | — | — | 10 | 10 | — | — | — | — | — | — | 20 |
| 3 | — | — | 10 | 10 | — | — | — | — | — | — | — |
| 4 | — | — | — | — | — | 15 | — | — | — | — | — |
| 5 | — | — | — | — | — | 4 | 3 | — | — | — | — |
| 6 | — | — | — | — | — | — | — | — | 10 | — | — |
| 7 | — | — | — | — | — | — | — | — | — | — | — |
| (C) Chain-like diol | | | | | | | | | | | |
| EG | — | — | — | 10 | — | — | 25 | — | — | 30 | — |
| PG | — | — | 40 | 40 | 30 | 40 | 20 | — | 25 | — | 10 |
| 13PD | — | — | — | — | — | — | 15 | — | 10 | — | — |
| NPG | 40 | — | — | — | — | — | 14 | 10 | 40 | — | — |
| (D) Other diols | | | | | | | | | | | |
| BPA-PO | — | — | — | — | — | — | 7 | — | — | — | — |
| (B) + (C) ratio (%) | 100 | 100 | 100 | 100 | 100 | 100 | 100 | 100 | 100 | 100 | 80 |
| (B)/(C) | 0.25 | 0.25 | 0.25 | 0.25 | 0.25 | 0.43 | 0.1 | 0.11 | 0.25 | 0.25 | 1 |
| (A) Dicarboxylic acid | | | | | | | | | | | |
| TPA | 50 | 45 | 50 | 50 | 50 | 40 | 48 | 50 | 47 | — | 50 |
| IPA | — | — | — | — | — | 10 | — | — | — | 47 | — |
| Glutaric acid | — | — | — | — | — | — | — | — | 3 | — | — |
| Sebacic acid | — | — | — | — | — | — | — | — | 3 | — | — |
| Succinic acid | 5 | — | — | — | — | — | — | — | — | — | — |
| Mw | 58000 | 61000 | 63000 | 53000 | 55000 | 59000 | 55000 | 63000 | 59000 | 65000 | 57000 |
| Mn | 4500 | 4700 | 4100 | 4100 | 4400 | 4500 | 4600 | 4500 | 4100 | 4900 | 4200 |
| Acid value (mg KOH/g) | 10.5 | 12 | 13.5 | 13.5 | 13 | 13.2 | 13 | 11.5 | 13.5 | 10.9 | 13.8 |
| Tg (° C.) | 64 | 62 | 58 | 59 | 61 | 57 | 58 | 57 | 62 | 57 | 59 |

| | Comparative Example | | | | |
|---|---|---|---|---|---|
| | C1 | C2 | C3 | C4 | C5 |
| Toner, developer, resin | C1 | C2 | C3 | C4 | C5 |
| particle dispersion No. | | | | | |
| Specific or comparative | C1 | C2 | C3 | C4 | C5 |
| polyester No. | | | | | |
| (B) Rosin diol | | | | | |
| 1 | — | — | 12 | — | 10 |
| 2 | — | 15 | 15 | — | — |
| 3 | — | — | — | — | — |
| 4 | — | — | — | — | — |
| 5 | — | — | — | — | — |
| 6 | — | — | — | — | — |
| 7 | — | — | — | — | — |
| (C) Chain-like diol | | | | | |
| EG | — | — | — | 20 | — |
| PG | 40 | — | 23 | 27 | 12 |
| 13PD | — | 5 | — | — | — |
| NPG | 40 | — | — | — | — |
| (D) Other diols | | | | | |
| BPA-PO | 10 | — | — | — | 28 |
| (B) + (C) ratio (%) | 80 | 90 | 100 | 100 | 56 |
| (B)/(C) | 0.25 | 0.11 | 1.17 | 0.06 | 0.83 |
| (A) Dicarboxylic acid | | | | | |
| TPA | 50 | 45 | 50 | 45 | 45 |
| IPA | — | — | — | — | — |
| Glutaric acid | — | 5 | — | 5 | — |
| Sebacic acid | — | — | — | — | — |
| Succinic acid | 5 | — | — | — | 5 |
| Mw | 64000 | 66000 | 63000 | 6000 | 59000 |
| Mn | 4800 | 4200 | 4000 | 4400 | 4800 |
| Acid value (mg KOH/g) | 13.5 | 10.5 | 13 | 12 | 12.5 |
| Tg (° C.) | 61 | 60 | 60 | 61 | 60 |

Abbreviations in Table 1 are as follows:
EG: Ethylene glycol
PG: Propylene glycol
13-PD: 1,3-Propanediol
NPG: Neopentyl glycol
BPA-PO: Bisphenol A propylene oxide adduct
TPA: Terephthalic acid
IPA: Isobutyl alcohol

### Preparation of Toner 1

### Preparation of Resin Particle Dispersion 1

### Preparation of Polyester Resin Particle Dispersion 1

After 100 parts by mass of the specific polyester resin 1 is put into a reactor equipped with a stirrer, dissolved at 120° C. for 30 minutes and mixed, an aqueous solution for neutralization in which 1.0 part by mass of sodium dodecyl benzene sulfonate and 1.0 part by mass a 1 N NaOH solution were dissolved in 800 parts by mass of ion exchange water which is heated to 95° C. is put into a flask, and after emulsifying for 5 minutes with a homogenizer (manufactured by IKA Works, Inc., ULTRA-TURRAX), the flask is further shaken for 10 minutes in a ultrasonic bath and cooled with room temperature water. Thus, a resin particle dispersion A1 in which the median diameter of the resin particle is 250 nm and the solid content is 20% by mass is obtained.

### Preparation of Colorant Particle Dispersion 1

Cyan pigment 50 parts by mass (manufactured by Dainichiseika Color & Chemicals Mfg. Co., Ltd., copper phthalocyanine, C. I. Pigment Blue 15:3)

Anionic surfactant (manufactured by Dai-ichi Kogyo Seiyaku Co., Ltd., NEOGEN R): 5 parts by mass

Ion exchange water: 200 parts by mass

The above-described components are mixed and dissolved, and the mixture is emulsified for 5 minutes with a homogenizer (manufactured by IKA Works, Inc., ULTRA-TURRAX) and for 10 minutes in a ultrasonic bath, whereby a cyan colorant particle dispersion 1 in which the solid content is 21.5% is obtained.

### Preparation of Release Agent Particle Dispersion 1

Anionic surfactant (manufactured by Dai-ichi Kogyo Seiyaku Co., Ltd., NEOGEN R): 2 parts by mass

Ion exchange water: 800 parts by mass

Paraffin wax (HNP9, manufactured by Nippon Seiro Co., Ltd.): 200 parts by mass

The above-described components are mixed and heated to 120° C., and dissolved, and a dispersing treatment was performed with a pressure discharging type gaulin homogenizer, whereby 20% by mass of a release agent dispersion in which the volume average particle diameter was 170 nm is obtained.

### —Preparation of Toner—

Polyester resin particle dispersion 1 (high molecular weight resin particle dispersion): 100 parts by mass

Colorant dispersion 1: 62 parts by mass

Anionic surfactant (Dowfax 2A1 20% aqueous solution): 15 parts by mass

Release agent dispersion 1: 77 parts by mass

First, among the above-described materials, the polyester resin particle dispersion 1, an anionic surfactant, and 250 parts by mass of ion exchange water are put into a polymerization tank equipped with a pH meter, a stirrer, and a thermometer, and the mixture is stirred at 130 rpm for 15 minutes such that the surfactant permeates the polyester resin particle dispersion. After to this, the colorant dispersion 1 and the release agent dispersion 1 are added, mixing is performed, and to this raw material mixture, 0.3 M nitric acid aqueous solution is added, and then, pH thereof is adjusted to be 4.8. Then, while applying a shearing force at 3000 rpm by the ULTRA-TURRAX, 13 parts by mass of 10% nitric acid aqueous solution of aluminum sulfate are added dropwise as a coagulant. Since during this coagulant dropping, viscosity of the raw material mixture is increased, when viscosity increased, the dropping rate is reduced to prevent the coagulant from being concentrated at one place. After the dropping of the coagulant is ended, the coagulant and the raw material mixture are sufficiently mixed by stirring for 5 minutes at a rotational rate of 5,000 rpm.

Then, the above raw material mixture is stirred at 500 rpm while heating at 25° C. in a mantle heater. Stirring is performed for 10 minutes, and after confirming that the primary particle size is formed using Coulter Multisizer II (aperture diameter: 50 μm, manufactured by Beckman Coulter Inc.), the temperature is raised to 43° C. at 1° C./min to grow aggregated particles. Growth of the aggregated particles is checked at any time using the Coulter Multisizer, an aggregation temperature or a rotational rate of the stirrer is changed according to the aggregation speed.

On the other hand, 118 parts by mass of ion exchange water and 8.2 parts by mass of an anionic surfactant (Dowfax 2A1 20% aqueous solution) are added to 160 parts by mass of the polyester resin particle dispersion 1 and mixing is performed, pH is adjusted to be 3.8 in advance, and the resultant mixture is used as a resin particle dispersion for coating the aggregated particles. When the aggregated particles are grown to be 5.2 μm in the above aggregation step, the previously prepared resin particle dispersion for coating is added thereto, and the mixture is held for 20 minutes while stirring. Thereafter, to stop the growth of the coated aggregated particles, 1.5 pph of EDTA is added, and 1M sodium hydroxide aqueous solution is added to control pH of the raw material mixture to be 7.6. Then, to fuse the aggregated particles, the temperature is raised to 85° C. at a temperature increase rate of 1° C./min while adjusting pH to be 7.6. After reaching 85° C., pH is adjusted to be 7.6 or less than to promote the fusion, and after confirming that the agglomerated particles are fused with an optical microscope, the temperature is rapidly cooled at a temperature decrease rate of 10° C./min by injecting ice water to stop the growth of a particle diameter.

Then, the obtained particles are sieved with a 15 μm mesh one time to purify. Thereafter, about 10 times ion exchange water (30° C.) with respect to the solid content is added, and after holding for 20 minutes, filtration is performed one time. Furthermore, the solid content remained on the filter paper is dispersed to make slurry, and washing with ion exchange water at 30° C. is repeated four times, followed by drying, whereby toner particles 1 having a volume average particle diameter of 6.1 μm is obtained.

The volume average particle size distribution index GSDv of the toner 1 (toner particles 1) is 1.23, and the form coefficient SF1 of the toner particles obtained from the form observation with Luzex is 128.

### Preparation of Developer 1

Using the obtained toner 1, a developer 1 is prepared in the following manner.

1.5 parts by mass of hydrophobic silica (manufactured by Cabot Corporation, TS720) is added to 50 parts by mass of the toner, and the mixture is mixed with a Sample Mill, whereby an externally added toner 1 is obtained.

Furthermore, using a ferrite carrier having an average particle diameter of 35 μm coated with 1% by mass of polymethyl acrylate resin (Mw: 80,000, manufactured by Soken Chemical & Engineering Co., Ltd.) as a carrier, the externally added toner 1 is weighed such that the toner concentration in the carrier becomes 5% by mass, and both are stirred and mixed for 5 minutes with a ball mill whereby the developer 1 is prepared.

### Preparation of Developers 2 to 11 and C1 to C5

### Preparation of Polyester Resin Particle Dispersions 2 to 11 and C1 to C5

First, polyester resin particle dispersions 2 to 11, and C1 to C5 are prepared in the same manner as in the polyester resin particle dispersion 1 except that each of the specific polyester resins 2 to 11, or each of the comparative polyester resins C1 to C5 is used instead of the specific polyester resin 1.

Subsequently, toners 2 to 11 and C1 to C5 are prepared in the same manner as in the toner 1 except that resin particle dispersions of the resin species according to Table 1 are used instead of the polyester resin dispersion 1. And developers 2 to 11 and C1 to C5 are prepared in the same manner as in the developer 1 except that these toners 2 to 11 and C1 to C5 are used.

### [Evaluation]

Evaluation of each developer obtained is performed in the following manner. The results are shown in Table 2.

### —Evaluation of Low Temperature Fixability—

A solid image is formed such that the toner amount becomes 0.9 mg/cm² on copy paper (J paper) manufactured by Fuji Xerox Co., Ltd. with each of the obtained developer, the image is fixed by a modified machine of Color Docutech-60 (manufactured by Fuji Xerox Co., Ltd.) under the conditions of a nip width of 6.5 mm and a fixing speed of 220 mm/sec, and evaluation of the low temperature fixability is performed. In the evaluation, while increasing the temperature of the fixer from 100° C. to 200° C. by 10° C., a fixed image is prepared at each fixing temperature, and a certain juice is coated on an image surface of each of the obtained fixed images, the image is folded, the folded portion is rubbed with gauze, then, the degree of peeling of the folded portion is observed, and the width of the paper that appears at the folded portion as a result of the peeling of the image is measured. The fixing temperature at which the width is 0.5 mm or less is taken as MFT (lowest fixing temperature, ° C.). The evaluation criteria are as follows.

### —Evaluation Criteria—

A: MFT is 120° C. or less, and the low temperature fixability is exhibited.
B: MFT is higher than 120° C. to 125° C. or less, and the low temperature fixability is slightly inferior to A.
C: MFT is higher than 125° C. to 130° C. or less, and the low temperature fixability is inferior to A.
D: MFT is higher than 130° C. to 135° C. or less, and the low temperature fixability is poorer than A.
E: MFT is higher than 135° C., and there is no the low temperature fixability.

### —Evaluation of Fixing Temperature Range—

Using the same device and the same solid images, the hot offset occurrence temperature is measured. In the evaluation, by increasing the temperature in a stepwise manner, the lowest temperature at which the hot offset occurs is measured. From the difference between the hot offset occurrence temperature and the lowest fixing temperature, the fixing temperature range is evaluated.

### —Evaluation Criteria—

A: The difference between the lowest fixing temperature and the hot offset occurrence temperature is 95° C. or higher.
B: The difference between the lowest fixing temperature and the hot offset occurrence temperature is 90° C. or higher and lower than 95° C.
C: The difference between the lowest fixing temperature and the hot offset occurrence temperature is 80° C. or higher and lower than 90° C.
D: The difference between the lowest fixing temperature and the hot offset occurrence temperature is 65° C. or higher and lower than 80° C.
E: The difference between the lowest fixing temperature and the hot offset occurrence temperature is lower than 65° C.

TABLE 2

| | | | Low | Fixing |
|---|---|---|---|---|
| | Developer | | temperature | temperature |
| | No. | Used resin type | fixability | range |
| Example 1 | 1 | Specific polyester | B | B |
| | | resin 1 | | |
| Example 2 | 2 | Specific polyester | A | A |
| | | resin 2 | | |
| Example 3 | 3 | Specific polyester | A | B |
| | | resin 3 | | |
| Example 4 | 4 | Specific polyester | C | B |
| | | resin 4 | | |
| Example 5 | 5 | Specific polyester | B | A |
| | | resin 5 | | |
| Example 6 | 6 | Specific polyester | B | B |
| | | resin 6 | | |
| Example 7 | 7 | Specific polyester | C | C |
| | | resin 7 | | |
| Example 8 | 8 | Specific polyester | B | B |
| | | resin 8 | | |
| Example 9 | 9 | Specific polyester | A | B |
| | | resin 9 | | |
| Example 10 | 10 | Specific polyester | A | C |
| | | resin 10 | | |
| Example 11 | 11 | Specific polyester | C | B |
| | | resin 11 | | |
| Comparative | C1 | Comparative | D | D |
| Example 1 | | polyester resin C1 | | |
| Comparative | C2 | Comparative | E | D |
| Example 2 | | polyester resin C2 | | |
| Comparative | C3 | Comparative | D | E |
| Example 3 | | polyester resin C3 | | |
| Comparative | C4 | Comparative | E | D |
| Example 4 | | polyester resin C4 | | |
| Comparative | C5 | Comparative | D | D |
| Example 5 | | polyester resin C5 | | |

From the above results, it is found that the developers in Examples have excellent low temperature fixability and wide fixing temperature ranges, compared to the developers in Comparative Examples.

### [Measurement Method of Various Physical Properties]

### <Measurement of Softening Temperature>

The softening temperature is determined as the temperature corresponding to half of the height of an end point from an outflow starting point when a sample of 1 cm³ is melted and flown out under the conditions of a diameter of a dice of 0.5 mm, a pressurized load of 0.98 MPa (10 kg/cm²), and a temperature increase rate of 1° C./min using a higher performance type flow tester CFT-500 (manufactured by Shimadzu Corporation).

### <Measurement of Glass Transition Temperature>

Using “DSC-20” (manufactured by SEIKO Electronics Industrial Co., Ltd.), 10 mg of the sample is heated at a constant temperature increase rate (10° C./min) and measurement is performed.

### <Measurement of Acid Value>

Acid values are measured by a neutralization titration method according to JIS K0070. That is, an appropriate amount of a sample is taken, 100 ml of a solvent (diethyl ether/ethanol mixture solution) and few drops of an indicator (phenolphthalein solution) are added thereto, and the mixture is sufficiently shaken until the sample is dissolved in a water bath. To this, 0.1 mol/l potassium hydroxide ethanol solution is titrated, and the time when the red color of the indicator has continued for 30 seconds is taken as the end point of the titration. When the acid value is A, the amount of sample is S (g), the amount of the 0.1 mol/l potassium hydroxide ethanol solution used in the titration is B (ml), and f is a factor of the 0.1 mol/l potassium hydroxide ethanol solution, the acid value is calculated by A=(B×f×5.611)/S.

### <Measurement of Weight Average Molecular Weight Mw and Number Average Molecular Weight Mn>

Two “HPL-8120 GPC and SC-8020 (manufactured by Tosoh Corporation, 6.0 mm ID×15 cm)” are used, and THF (tetrahydrofuran) is used as an eluent. The experiment is performed using an RI detector under the experimental conditions of a sample concentration of 0.5%, a flow rate of 0.6 ml/min, a sample injection amount of 10 μl, and a measurement temperature of 400° C. In addition, a calibration curve is created from 10 samples of “polystyrene standard sample TSK standard”: “A-500”, “F-1”, “F-10”, “F-80”, “F-380”, “A-2500”, “F-4”, “F-40”, “F-128”, and “F-700” manufactured by Tosoh Corporation.

### Synthesis Example 2-1

### Synthesis of rosin diol 11 (exemplified compound (7A))

90 parts by mass of propylene glycol diglycidyl (reagent, manufactured by Wako Pure Chemical Industries, Ltd.) as a bifunctional epoxy compound, 200 parts by mass of disproportionated rosin (trade name: Pine Crystal KR614 manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 11 is obtained.

### Synthesis Example 2-2

### Synthesis of rosin diol 12 (exemplified compound (9A))

100 parts by mass of neopentyl glycol diglycidyl (reagent, manufactured by Tokyo Chemical Industry Co., Ltd.) as a bifunctional epoxy compound, 200 parts by mass of disproportionated rosin (trade name: Pine Crystal KR614, manufactured by Arakawa Chemical Industries, Co., Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 12 is obtained.

### Synthesis Example 2-3

### Synthesis of rosin diol 13 (exemplified compound (6A))

80 parts by mass of ethylene glycol diglycidyl (reagent, manufactured by Wako Pure Chemical Industries, Co., Ltd.) as a bifunctional epoxy compound, 200 parts by mass of disproportionated rosin (trade name: Pine Crystal KR614 manufactured by Arakawa Chemical Industries, Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 13 was obtained.

### Synthesis Example 2-4

### Synthesis of rosin diol 14 (exemplified compound (16A))

90 parts by mass of propylene glycol diglycidyl (reagent, manufactured by Wako Pure Chemical Industries, Co., Ltd.) as a bifunctional epoxy compound, 205 parts by mass of hydrogenated rosin (trade name: Pine Crystal KR614 manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 14 is obtained.

### Synthesis Example 2-5

### Synthesis of rosin diol 15 (exemplified compound (4A))

100 parts by mass of neopentyl glycol diglycidyl (reagent, manufactured by Tokyo Chemical. Industry Co., Ltd.) as a bifunctional epoxy compound, 200 parts by mass of purified rosin (trade name: Pine Crystal KR65, manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 15 is obtained.

### Synthesis Example 2-6

### Synthesis of rosin diol 16 (exemplified compound (6A))

80 parts by mass of ethylene glycol diglycidyl (reagent, manufactured by Wako Pure Chemical Industries, Co., Ltd.) as a bifunctional epoxy compound, 200 parts by mass of low disproportionation ratio rosin (in which trade name Pine Crystal KR65 manufactured by Arakawa Chemical Industries, Co., Ltd. and Pine Crystal KR614, manufactured by Arakawa Chemical Industries, Ltd. are mixed at a equivalent molar ratio, and a disproportionation ratio is reduced to ½ of Pine Crystal KR614) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 16 is obtained.

### Synthesis Example 2-7

### Synthesis of rosin diol 17 (exemplified compound (15A))

100 parts by mass of neopentyl glycol diglycidyl (reagent, manufactured by Tokyo Chemical Industry Co., Ltd.) as a bifunctional epoxy compound, 205 parts by mass of hydrogenated rosin (trade name: HYPALE CH, manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 17 was obtained.

### Synthesis Example 2-8

### Synthesis of rosin diol 18 (comparative rosin diol)

115 parts by mass of bisphenol A diglycidyl (reagent, manufactured by Tokyo Chemical Industry Co., Ltd.) as a bifunctional epoxy compound, 200 parts by mass of disproportionated rosin (trade name: Pine Crystal KR614, manufactured by Arakawa Chemical Industries, Co., Ltd.) as a rosin component, and 0.2 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 18 is obtained.

### Synthesis Example 2-9

### Synthesis of rosin diol 19 (comparative rosin diol)

105 parts by mass of Terephthalic acid diglycidyl (trade name: Denacol EX711, manufactured by Nagase ChemteX Corporation, epoxy equivalent (g/eq)) as a bifunctional epoxy compound, 200 parts by mass of hydrogenated rosin (trade name: HYPALE CH, manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 19 was obtained.

### Synthesis Example 2-10

### Synthesis of rosin diol 20 (comparative rosin diol)

130 parts by mass of polypropylene glycol diglycidyl ether (trade name: EX920, manufactured by Nagase ChemteX Corporation) as a bifunctional epoxy compound, 200 parts by mass of disproportionated rosin (trade name: Pine Crystal KR614, manufactured by Arakawa Chemical Industries, Co., Ltd.) as a rosin component, and 0.4 parts by mass of tetraethyl ammonium bromide (manufactured by Tokyo Chemical Industry Co., Ltd.) as a reaction catalyst are put into a reaction vessel made of stainless equipped with a stirrer, a heater, a cooling tube, and a thermometer, the temperature is raised to 130° C., and a ring opening reaction of an acid group of the rosin and an epoxy group of the epoxy compound is performed.

The reaction is continuously performed at the same temperature for 4 hours, and when the acid value reaches 0.5 mg KOH/g, the reaction is stopped, whereby a rosin diol 20 is obtained.

### Synthesis Example 2A

### Synthesis of Specific Polyester Resin 1

80 g of terephthalic acid (TPA) as a polycarboxylic acid component, 6 g of succinic acid, 60 g of the rosin diol 11 and 40 g of neopentyl glycol as a polyol component, and 0.1 g of tetra-n-butyl titanate as a reaction catalyst are put into a reaction vessel made of stainless equipped with a stirrer, a heater, a thermometer, a fractional distillation device, and a nitrogen gas inlet tube, a polycondensation reaction is performed at 230° C. for 9 hours in a nitrogen atmosphere while stirring, and it is confirmed that the molecular weight and the acid value reaches desired values, whereby a specific polyester resin 1 is synthesized. The weight average molecular and the glass transition temperature are measured (described in Table).

### Synthesis of Other Polyester Resin

In the same manner as in the synthesis of the specific polyester resin 1 in Synthesis Example 2A, using components described in the following Tables 3 and 4, specific polyester resins and comparative polyester resins are synthesized.

Here, specific polyester resins and comparative polyester resins are prepared in the amounts of the components calculated from the molar fractions in Tables 3 and 4 such that the total amount of the polycarboxylic acid component and the polyol component becomes 1 mole.

In addition, tetra-n-butyl titanate of 0.1 g is used in all of the specific polyester resins 2 to 15 and the comparative polyester resins 1 to 5.

Physical properties of the obtained polyester resins are measured by the method described above. The measurement results are also shown in Tables 3 and 4. Moreover, “C1/C2” in Tables 1 and 2 represents the carbon number C1 which a divalent group which L¹ in the specific rosin diol represents and the carbon number C2 which the aliphatic polycarboxylic acid has.

### Example 2-1

### Preparation of Toner 1

### Preparation of Specific Polyester Resin Particle Dispersion 1

After 100 parts by mass of the specific polyester resin 1 is put into a reactor equipped with a stirrer, dissolved at 120° C. for 30 minutes and mixed, an aqueous solution for neutralization in which 1.0 part by mass of sodium dodecyl benzene sulfonate and 1.0 part by mass a 1 N NaOH solution are dissolved in 800 parts by mass of ion exchange water which is heated to 95° C. is put into a flask, and after emulsifying for 5 minutes with a homogenizer (manufactured by IKA Works, Inc., ULTRA-TURRAX), the flask is further shaken for 10 minutes in a ultrasonic bath and cooled with room temperature (25° C.) water. Thus, a specific polyester resin particle dispersion 1 in which the median diameter of the resin particle is 250 nm and the solid content is 20% by mass is obtained.

### Preparation of Colorant Particle Dispersion 1

Cyan pigment: 50 parts by mass (manufactured by Dainichiseika Color & Chemicals Mfg. Co., Ltd, copper phthalocyanine, C. I. Pigment Blue 15:3)

Anionic surfactant (manufactured by Dai-ichi Kogyo Seiyaku Co., Ltd., NEOGEN R): 5 parts by mass

Ion exchange water: 200 parts by mass

The above-described components are mixed and dissolved, and the mixture is emulsified for 5 minutes with a homogenizer (manufactured by IKA Works, Inc., ULTRA-TURRAX) and for 10 minutes in an ultrasonic bath, whereby a cyan colorant particle dispersion 1 in which the center diameter is 190 nm and the solid content is 21.5% is obtained.

### Preparation of Release Agent Particle Dispersion 1

Anionic surfactant (manufactured by Dai-ichi Kogyo Seiyaku Co., Ltd., NEOGEN R): 2 parts by mass

Ion exchange water: 800 parts by mass

Paraffin wax (HNP-9, manufactured by Nippon Seiro Co., Ltd.): 200 parts by mass

The above-described components are mixed and heated to 120° C., and dissolved, and a dispersing treatment is performed with a pressure discharging type gaulin homogenizer, whereby 20% by mass of a release agent particle dispersion 1 in which the volume average particle diameter is 170 nm is obtained.

### Preparation of Toner Particles 1

Polyester resin particle dispersion 1 (high molecular weight resin particle dispersion): 200 parts by mass

Colorant dispersion 1: 62 parts by mass

Anionic surfactant (Dowfax 2A1 20% aqueous solution): 15 parts by mass

Release agent particle dispersion 1: 77 parts by mass

First, among the above-described materials, the polyester resin particle dispersion 1, an anionic surfactant, and 250 parts by mass of ion exchange water are put into a polymerization tank equipped with a pH meter, a stirrer, and a thermometer, and the mixture is stirred at 130 rpm for 15 minutes such that the surfactant permeates the polyester resin particle dispersion. After to this, the colorant dispersion 1 and the release agent dispersion 1 are added, mixing is performed, and to this raw material mixture, 0.3 M nitric acid aqueous solution is added, and then, pH thereof is adjusted to be 4.8. Then, while applying a shearing force at 3000 rpm by the ULTRA-TURRAX, 13 parts by mass of 10% nitric acid aqueous solution of aluminum sulfate are added dropwise as a coagulant. Since during this coagulant dropping, viscosity of the raw material mixture is increased, when viscosity increased, the dropping rate is reduced to prevent the coagulant from being concentrated at one place. After the dropping of the coagulant is ended, the coagulant and the raw material mixture are sufficiently mixed by stirring for 5 minutes at a rotational rate of 5,000 rpm.

Then, the above raw material mixture is stirred at 500 rpm while heating at 25° C. in a mantle heater. Stirring is performed for 10 minutes, and after confirming that the primary particle size is formed using Coulter Multisizer II (aperture diameter: 50 μm, manufactured by Beckman Coulter Inc.), the temperature is raised to 43° C. at 0.1° C./min to grow aggregated particles. Growth of the aggregated particles is checked at any time using the Coulter Multisizer, an aggregation temperature or a rotational rate of the stirrer is changed according to the aggregation speed.

On the other hand, 118 parts by mass of ion exchange water and 8.2 parts by mass of an anionic surfactant (Dowfax 2A1 20% aqueous solution) are added to 160 parts by mass of the polyester resin particle dispersion 1 and mixing is performed, pH is adjusted to be 3.8 in advance, and the resultant mixture is used as a resin particle dispersion for coating the aggregated particles. When the aggregated particles are grown to be 5.2 μm in the above aggregation step, the previously prepared resin particle dispersion for coating is added thereto, and the mixture is held for 20 minutes while stirring. Thereafter, to stop the growth of the coated aggregated particles, 1.5 pph of EDTA is added, and 1M sodium hydroxide aqueous solution is added to control pH of the raw material mixture to be 7.6. Then, to fuse the aggregated particles, the temperature is raised to 85° C. at a temperature increase rate of 1° C./min while adjusting pH to be 7.6. After reaching 85° C., pH is adjusted to be 7.6 or less than to promote the fusion, and after confirming that the agglomerated particles are fused with an optical microscope, the temperature is rapidly cooled at a temperature decrease rate of 10° C./min by injecting ice water to stop the growth of a particle diameter.

Then, the obtained particles are sieved with a 15 μm mesh one time to purify. Thereafter, about 10 times ion exchange water (30° C.) with respect to the solid content is added, and after holding for 20 minutes, filtration is performed one time. Furthermore, the solid content remained on the filter paper is dispersed to make slurry, and washing with ion exchange water at 30° C. is repeated four times, followed by drying, whereby toner particles 1 having a volume average particle diameter of 6.5 μm is obtained.

The volume average particle size distribution index GSDv of the toner 1 (toner particles 1) is 1.24, and the form coefficient SF1 of the toner particles obtained from the form observation with Luzex is 129.

### Preparation of Developer 1

Using the obtained toner particles 1, a developer 1 is prepared as follows.

1.5 parts by mass of hydrophobic silica (manufactured by Cabot Corporation, TS720) is added to 50 parts by mass of the toner particle 1, and the mixture is mixed with a Sample Mill, whereby a toner 1 is obtained.

Furthermore, using a ferrite carrier having an average particle diameter of 35 μm coated with 1% by mass of polymethyl acrylate resin (Mw: 80,000, manufactured by Soken Chemical & Engineering Co., Ltd.) as a carrier, the toner 1 is weighed such that the toner concentration in the carrier become 5% by mass, and both are stirred and mixed for 5 minutes with a ball mill whereby the developer 1 is prepared.

### <Evaluation>

Evaluation of the obtained developer 1 is performed as follows. The results are shown in Table 3.

### —Destruction of Toner—

The obtained developer is stirred under the following conditions.

Using a remodeled DocuCentre Color 500 manufactured by Fuji Xerox Co., Ltd. and an S paper manufactured by Fuji Xerox Co., Ltd., the strength of a toner is evaluated under the following conditions. After 50,000 sheets are successively printed at an image density of 2%, the presence of collapse, destruction, and aggregation of the toner are visually observed, and evaluation is performed based on the following criteria.

The result of evaluation of the toner is a level B in which toner collapse, destruction, aggregation of the toner do not occur and there is no practical problem. The toner after stirring is observed by scanning electron microscope (SEM).

The evaluation criteria were as follows.

A: Level with no problem, in which collapse and destruction of the toner are not observed.
B: Level with no problem, in which collapse and destruction of the toner are slightly observed.
C: Level with no practical problem, in which collapse, destruction, and aggregation of the toner are somewhat observed.
D: Level affecting practical image quality, in which collapse, and destruction of the toner are observed.
E: Level with a serious practical problem, in which collapse, destruction, and aggregation of the toner are significantly observed.

When the evaluation criterion is C or higher, there is no practical problem.

### —Evaluation of Fixability—

By evaluating fixability, a phenomenon in which a transfer of the toner (referred to as “offset phenomenon”) to a member such as a fixing roller or a paper feeding roller due to destruction of the toner occurs, and contamination of an image occurs is confirmed.

In the evaluation of the fixability, specifically, a developer is loaded in the remodeled DocuCentre Color 500 manufactured by Fuji Xerox Co., Ltd. and images of 10,000 sheets of print test charts with an image density of 1% are formed on color copy papers (J paper) manufactured by Fuji Xerox Co., Ltd., in an environment of 28° C./85% RH. The surfaces of the images are visually observed, and the presence of mark streaks of the paper feeding roller is evaluated according to the following criteria.

The results are shown in Tables 3 and 4.

A: Streaks of roll mark are not observed at all.
B: Streaks of roll mark are not observed to 9,000 sheets, and are slightly observed at 10,000 sheets.
C: Streaks of roll mark are slightly observed from 5,000 sheets.
D: Streaks of roll mark are clearly observed from 5,000 sheets.

When the evaluation criterion is B or higher, there is no practical problem.

### Examples 2-2 to 2-15 and Comparative Examples 2-1 to 2-5

### Developers 2 to 15 and Comparative Developers 1 to 5

In the same manner as in the polyester resin particle dispersion 1, according to the composition ratio in Tables 3 and 4, specific polyester resins 2 to 15 and comparative polyester resins 1 to 5 are prepared.

Here, specific polyester resins and comparative polyester resins are prepared in the amounts of the components calculated from the molar fractions in Tables 3 and 4 such that the total amount of the polycarboxylic acid component and the polyol component becomes 1 mole.

In addition, tetra-n-butyl titanate of 0.1 g is used in all of the specific polyester resins 2 to 15 and the comparative polyester resins 1 to 5.

Then, specific polyester resin particle dispersions 2 to 15 and comparative polyester resin particle dispersions 1 to 5 to which these polyester resins are applied are prepared in the same manner as in the specific polyester resin particle dispersion 1, and developers 2 to 15 and comparative developers 1 to 5 are prepared in the same manner as in the developer 1.

Moreover, specific polyester resin particle dispersions 2 to 15 and comparative polyester resin particle dispersions 1 to 5 are prepared in the following manner.

### Preparation of Specific Polyester Resin Particle Dispersions 2 to 15 and Comparative Polyester Resin Particle Dispersions 1 to 5

Specific polyester resin particle dispersions 2 to 15 and comparative polyester resin particle dispersions 1 to 5 are prepared in the same manner as in the polyester resin particle dispersion 1 except that each of the specific polyester resin dispersions 1 to 15, or each of the comparative polyester resin particle dispersions 1 to 5 is used instead of the specific polyester resin 1.

The obtained developers 2 to 15 and comparative developers 1 to 5 are evaluated in the same manner as in Example 2-1. The results are shown in Tables 3 and 4.

TABLE 3

| | Example | Example | Example | Example | Example | Example | Example | Example | Example | Example | Example |
|---|---|---|---|---|---|---|---|---|---|---|---|
| | 2-1 | 2-2 | 2-3 | 2-4 | 2-5 | 2-6 | 2-7 | 2-8 | 2-9 | 2-10 | 2-11 |
| | Specific | Specific | Specific | Specific | Specific | Specific | Specific | Specific | Specific | Specific | Specific |
| | pol- | pol- | pol- | pol- | pol- | pol- | pol- | pol- | pol- | pol- | pol- |
| | yester | yester | yester | yester | yester | yester | yester | yester | yester | yester | yester |
| | resin 1 | resin 2 | resin 3 | resin 4 | resin 5 | resin 6 | resin 7 | resin 8 | resin 9 | resin 10 | resin 11 |
| Polyol | | | | | | | | | | | |
| component | | | | | | | | | | | |
| (molar | | | | | | | | | | | |
| fraction) | | | | | | | | | | | |
| Rosin diol 11 | 10 | — | — | — | — | — | — | — | — | 5 | — |
| Rosin diol 12 | — | 10 | — | — | — | — | 10 | 10 | — | — | — |
| Rosin diol 13 | — | — | — | 10 | — | — | — | — | — | — | — |
| Rosin diol 14 | — | — | — | — | 5 | — | — | — | — | — | — |
| Rosin diol 15 | — | — | — | — | 15 | — | — | — | — | 5 | — |
| Rosin diol 16 | — | — | — | 10 | — | — | — | — | 10 | — | — |
| Rosin diol 17 | — | — | — | — | — | — | — | — | 3 | — | — |
| Rosin diol 18 | — | — | — | — | — | — | — | — | — | — | — |
| Rosin diol 19 | — | — | — | — | — | — | — | — | — | — | — |
| Ethylene | — | — | — | 25 | — | — | — | — | — | — | — |
| glycol | | | | | | | | | | | |
| Propylene | — | 40 | 30 | 20 | — | 40 | 40 | 40 | — | 30 | — |
| glycol | | | | | | | | | | | |
| 1,3-Propanediol | — | — | — | 10 | — | — | — | — | — | — | — |
| Neopentyl | 40 | — | — | — | 10 | — | — | — | 17 | — | — |
| glycol | | | | | | | | | | | |
| BPA-PO* | — | 10 | — | 5 | 5 | — | — | 30 | — | 40 | — |
| 1,4-butanediol | — | — | — | — | — | 5 | — | — | — | 10 | — |
| Polycarboxylic | | | | | | | | | | | |
| component | | | | | | | | | | | |
| (molar | | | | | | | | | | | |
| fraction) | | | | | | | | | | | |
| Terephthalic | 45 | 45 | 35 | 45 | 43 | 45 | 46 | 25 | 44 | 47 | — |
| acid | | | | | | | | | | | |
| Isophthalic | — | — | — | — | — | — | — | | 20 | — | 45 |
| acid | | | | | | | | | | | |
| Sebacic acid | — | — | — | — | — | — | — | 2 | — | — | — |
| Adipic acid | — | — | — | — | 4 | — | 2 | — | 5 | — | 5 |
| Succinic acid | 5 | 5 | 15 | 5 | 3 | 10 | — | — | 4 | 3 | — |
| Mw | 62000 | 59000 | 55000 | 68000 | 59000 | 58000 | 58000 | 59000 | 49000 | 60000 | 65000 |
| Mn | 3900 | 4100 | 3500 | 3500 | 4800 | 4500 | 4200 | 4300 | 3800 | 4500 | 4300 |
| Acid value | 10.6 | 11.5 | 10.2 | 13.5 | 12 | 14.5 | 12 | 10.8 | 13.7 | 11.6 | 10.5 |
| (mg KOH/g) | | | | | | | | | | | |
| Tg (° C.) | 62 | 60 | 58 | 57 | 57 | 59 | 59 | 58 | 57 | 58 | 56 |
| C1/C2 | 5/4 | 7/4 | 4/4 | 5/4 | 7/4 | 4/4 | 7/6 | 7/8 | 7/4, 7/6 | 5/4, 7/4 | 7/6 |
| Aliphatic | 1 | 10 | 30 | 10 | 6 | 20 | 8 | 4 | 12 | 6 | 10 |
| carboxylic | | | | | | | | | | | |
| acid/entire | | | | | | | | | | | |
| carboxylic | | | | | | | | | | | |
| acid | | | | | | | | | | | |
| component | | | | | | | | | | | |
| (mol %) | | | | | | | | | | | |
| Evaluation | | | | | | | | | | | |
| Toner | A | A | A | A | A | A | A | B | B | A | C |
| destruction | | | | | | | | | | | |
| Fixability | B | A | B | A | B | A | A | A | A | A | B |

*Bisphenol A propylene oxide adduct

TABLE 4

| | | | | | Com- | Com- | Com- | Com- | Com- |
|---|---|---|---|---|---|---|---|---|---|
| | | | | | parative | parative | parative | parative | parative |
| | Example | Example | Example | Example | Example 2-1 | Example 2-2 | Example 2-3 | Example 2-4 | Example 2-5 |
| | 2-12 | 2-13 | 2-14 | 2-15 | Com- | Com- | Com- | Com- | Com- |
| | Specific | Specific | Specific | Specific | parative | parative | parative | parative | parative |
| | polyester | polyester | polyester | polyester | polyester | polyester | polyester | polyester | polyester |
| | resin 12 | resin 13 | resin 14 | resin 15 | resin 1 | resin 2 | resin 3 | resin 4 | resin 5 |
| Polyol | | | | | | | | | |
| component | | | | | | | | | |
| (parts by mass) | | | | | | | | | |
| Rosin diol 11 | | | | | | | | | |
| Rosin diol 12 | | | 10 | 10 | | | | | |
| Rosin diol 13 | 4 | | | | | 10 | | | |
| Rosin diol 14 | | | | | | | | | |
| Rosin diol 15 | 5 | | | | | | | | |
| Rosin diol 16 | | | | | | | | | |
| Rosin diol 17 | | | | | 12 | | | | |
| Rosin diol 18 | | | | | | | 10 | | |
| Rosin diol 19 | | | | | | | | 10 | |
| Rosin diol 20 | | | | | | | | | 10 |
| Ethylene glycol | | | | | | | | | |
| Propylene glycol | | 30 | | | | | | | |
| 1,3-Propanediol | 15 | 16 | 40 | 40 | 38 | 40 | 40 | 35 | 40 |
| Neopentyl glycol | 10 | | | | | | | 5 | |
| BPA-PO* | 10 | | | | | | | | |
| 1,4-butanediol | | | | | | | | | |
| Polycarboxyic | | | | | | | | | |
| acid | | | | | | | | | |
| component | | | | | | | | | |
| (parts by mass) | | | | | | | | | |
| Terephthalic | 25 | 34 | 45 | 45 | 50 | 45 | 45 | 40 | 49 |
| acid | | | | | | | | | |
| Isophthalic | 24.4 | | | | | | | 5 | |
| acid | | | | | | | | | |
| Azelaie acid | | | | | | 5 | | | |
| Sebacic acid | | | | | | | | | 1 |
| Adipic acid | | | | | | | | 2 | |
| Succinic acid | 0.4 | 16 | 5 | 5 | | | 5 | | |
| Mw | 60000 | 74000 | 19000 | 91000 | 65000 | 60000 | 57000 | 59000 | 61000 |
| Mn | 4100 | 4500 | 3200 | 5200 | 4900 | 4300 | 4400 | 4100 | 3900 |
| Acid value | 14 | 10.2 | 14.8 | 10.1 | 11 | 13.3 | 12.5 | 13 | 13.5 |
| (mg KOH/g) | | | | | | | | | |
| Tg (° C.) | 57 | 57 | 58 | 60 | 62 | 57 | 60 | 59 | 59 |
| Cl/C2 | 7/4 | 4/4 | 7/4 | 7/4 | 7/None | 4/9 | None/4 | None/6 | None/8 |
| Aliphatic | 0.8 | 32 | 10 | 10 | 0 | 10 | 10 | 4 | 10 |
| carboxylic | | | | | | | | | |
| acid/ | | | | | | | | | |
| entire | | | | | | | | | |
| carboxylic | | | | | | | | | |
| acid | | | | | | | | | |
| component | | | | | | | | | |
| (mol %) | | | | | | | | | |
| Evaluation | | | | | | | | | |
| Toner | C | C | C | A | E | D | E | E | E |
| destruction | | | | | | | | | |
| Fixability | A | B | B | B | D | C | C | D | C |

*Bisphenol A propylene oxide adduct

From the above results, it is found that the developers in Examples suppress destruction of a toner, compared to the developers in Comparative Examples.

What is claimed is:

1. A polyester resin for a toner, which is a polycondensate of (A) a polycarboxylic acid component and a polyol component including (B) polyol represented by the following general formula (1) and (C) a chain-like aliphatic polyol,
wherein the total amount of (B) the polyol represented by the general formula (1) and (C) the chain-like aliphatic polyol is 60 mol % to 100 mol % in the entire alcohol components, and the molar ratio ((B)/(C)) of (B) the polyol represented by the general formula (1) to (C) the chain-like aliphatic polyol is 0.1 to 1.0: 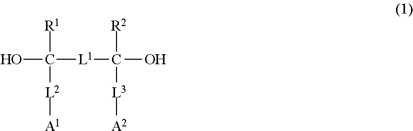
in the general formula (1),
each of R¹ and R² independently represents a hydrogen atom or a methyl group,
L¹ represents a chain-like alkylene group that may have a substituent, or a divalent group obtained by combining the chain-like alkylene group and an ester group or an ether group,
each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, or a divalent group obtained by combination thereof, and
L¹ and L² or L¹ and L³ may form a ring,
each of A¹ and A² represents a rosin ester group.

2. A polyester resin for a toner, which is a polycondensate of (A) a polycarboxylic acid component including aliphatic polycarboxylic acid and (B) a polyol component including polyol represented by the following general formula (1) in an amount of 50 mol % or less with respect to the entire polyol components,
wherein a carbon number C1 which a divalent group which L¹ in the polyol represented by the general formula (1) represents has and a carbon number C2 which the aliphatic polycarboxylic acid has satisfy the following relational formula (A):
Relational formula (A):
0.5<C1/C2≦3 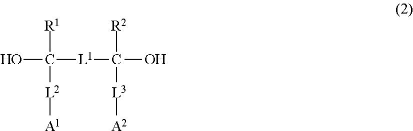
in the general formula (2),
each of R¹ and R² independently represents a hydrogen atom or a methyl group,
L¹ represents a chain-like alkylene group that may have a substituent, or a divalent group obtained by combining the chain-like alkylene group and an ester group or an ether group,
each of L² and L³ independently represents a divalent linking group selected from a group consisting of a carbonyl group, an ester group, an ether group, a sulfonyl group, a chain-like alkylene group that may have a substituent, a cyclic alkylene group that may have a substituent, an arylene group that may have a substituent, or a divalent group obtained by combination thereof, and
L¹ and L² or L¹ and L³ may form a ring,
each of A¹ and A² represents a rosin ester group.

3. The polyester resin for a toner according to claim 1,
wherein (C) the chain-like aliphatic polyol is at least one selected from a group consisting of 1,3-propanediol, ethylene glycol, 1,2-propanediol, and neopentyl glycol.

4. The polyester resin for a toner according to claim 1,
wherein (A) the polycarboxylic acid components are at least two of dicarboxylic acid including an aromatic structure and dicarboxylic acid including a chain-like aliphatic structure having a carbon number of 4 or less.

5. The polyester resin for a toner according to claim 2,
wherein (A) the aliphatic polycarboxylic acid is included in an amount of 1 mol % to 30 mol % with respect to the entire polycarboxylic acid components.

6. The polyester resin for a toner according to claim 2,
wherein (A) the aliphatic polycarboxylic acid is aliphatic polycarboxylic acid having a carbon number of 4 to 6.

7. The polyester resin for a toner according to claim 2,
wherein alcohol other than the polyol represented by the general formula (1) included in (B) the polyol component is polyol having a carbon number of 5 or less.

8. A toner for electrostatic charge image development, comprising:
the polyester resin for a toner according to claim 1.

9. A toner for electrostatic charge image development, comprising:
the polyester resin for a toner according to claim 2.

10. A toner cartridge comprising:
the toner for electrostatic charge image development according to claim 8.

11. A toner cartridge comprising:
the toner for electrostatic charge image development according to claim 9.
